(19) United States
(12) Patent Application Publication
(10) Pub. No.: US 2015/0114460 A1
(43) Pub. Date: Apr. 30, 2015

(54) CONDUCTIVE COMPOSITION AND APPLICATIONS THEREOF

(71) Applicant: National Cheng Kung University, Tainan (TW)

(72) Inventors: Jyh-Ming TING, Tainan (TW); Chih-Ching CHANG, Tainan (TW)

(73) Assignee: National Cheng Kung University, Tainan (TW)

(21) Appl. No.: 14/263,362

(22) Filed: Apr. 28, 2014

(30) Foreign Application Priority Data
Oct. 28, 2013 (TW) 102138869

(51) Int. Cl. H01G 9/20; B01J 35/00; B01J 37/34; B01J 31/06

(52) U.S. Cl. CPC H01G 9/2022; B01J 31/06; B01J 35/0033; B01J 37/343
USPC 136/256; 502/1

(57) ABSTRACT

The present invention relates to a conductive composition, comprising: poly-(3,4-ethylenedioxythiophene): poly-(styrenesulfonic acid); and a surfactant; in which the surfactant has a concentration of 1 to 10% by weight based on the total weight of the composition, and the conductive composition does not comprise any metal component. The present invention also relates to a cathode catalyst layer prepared by said conductive composition, and a method for preparing a cathode catalyst layer with said conductive composition.

### CROSS REFERENCE TO RELATED APPLICATION

This application claims the benefits of the Taiwan Patent Application Serial Number 102138869, filed on Oct. 28, 2013, the subject matter of which is incorporated herein by reference.

### BACKGROUND OF THE INVENTION

1. Field of the Invention

The present invention relates to a conductive composition, a cathode catalyst layer prepared by the same, and a method for preparing a cathode catalyst layer with the same.

2. Description of Related Art

After industrial revolution, the demand for energy is increased as the technology developed. Nowadays, many studies focus on the alternative energy due to oil crisis. Especially, after the 3/11 earthquake in Japan, the explosion of the nuclear power plant arises the conscious of the importance of the alternative energy.

A solar cell is an alternative energy actively developed in worldwide. The first developed and mature solar cell is the Si-based solar cell. According to the crystallization of Si, the Si-based solar cell can be divided into the monocrystalline Si solar cell, the polycrystalline Si solar cell and the amorphous Si solar cell. Currently, the efficiency of the monocrystalline Si solar cell fabricated in a lab can achieve 25%. However, the preparation process is complicated and the manufacturing cost is still high, so it is difficult to apply the monocrystalline Si solar cell as a daily used device. In order to reduce the manufacturing cost of the solar cell, the polycrystalline Si solar cell and the amorphous Si solar cell are sequentially developed. However, these two kinds of the Si solar cell still has the problem that the efficiency and the thermal stability are not good enough due to the existence of crystal grain boundary. In addition, for the purpose of flexibility and portability, thin film solar cells including monocrystalline Si thin film, polycrystalline Si thin film, amorphous Si thin film, binary compound semiconductor such as III-V semiconductor (GaAs) and II-VI semiconductor (CdTe), ternary compound semiconductor such as CuInSe₂, and tertiary compound semiconductor such as CulnGaSe are also developed. Among the aforementioned thin film solar cells, CdTe and CulnGaSe (CIGS) solar cells are the most well-known. The CdTe solar cell fabricated by First Solar can achieve 18.7%, but there is a doubt about the Cd pollution. The CIGS solar cell fabricated by NREL has high efficiency about 20% and high stability, and can be long-term used. However, the content of In is limited. Hence, the aforementioned solar cells still have many limitations in the manufacturing cost and the preparation process thereof.

In 1991, Michael Grätzel published a novel dye-sensitized solar cell (DSC), wherein TiO₂ having high specific surface area is used as a photoanode, dye Ru(depby)₂{(μ-CN)Ru(CN)(bpy)₂}₂ is adsorbed thereto, iodide (F) and triiodide (I³⁻) are used as an electrolyte, and Pt on the counter electrode is used as a catalyst layer to reduce the triiodide. The efficiency of this obtained solar cell is more than 7%.

The advantage of the DSC is the simple preparation process and the low manufacturing cost, and it can be prepared with a plastic substrate. Hence, the DSC has potential to replace the aforementioned solar cells. However, the lifetime of the DSC is shorter than the conventional Si-based solar cells, and this is why the DSC still cannot be commercialized. Another reason why the DSC still cannot be commercialized is that the counter electrode thereof is fabricated with Pt, which is a precious metal. Hence, it is desirable to provide a cheap material for the counter electrode of the DSC, which has low resistance and high catalytic capacity to the electrolyte.

### SUMMARY OF THE INVENTION

In a dye-sensitized solar cell (DSC), I₃⁻ ions in an electrolyte are reduced into IF ions by electrons from an external circuit at a counter electrode thereof. If the I₃⁻ ions cannot effectively reduced into the I⁻ ions, dyes cannot be regenerated, resulting in the open circuit voltage, the conversion efficiency and the life time of the DSC reduced. Hence, the material used for the counter electrode has to have excellent catalytic capacity. Nowadays, the most used material for the counter electrode is Pt. However, Pt is rare and expensive, and thus many materials are sequentially developed to replace Pt as the material for the counter electrode. Among the developed materials, most of them are carbon materials and conductive polymers. In the present invention, a conductive composition containing poly-(3,4-ethylenedioxythiophene): poly-(styrenesulfonic acid) (PEDOT:PSS) and a surfactant is developed, which is cheap and can be used to fabricate a counter electrode of a DSC in a simple way. In addition, the photoelectric conversion efficiency of the DSC fabricated with the aforementioned conductive composition is as high as that fabricated with the conventional Pt electrode.

An object of the present invention is to provide a conductive composition, which contains cheap and easily available conductive polymer and does not contain any metal component, especially expensive metal component.

Another object of the present invention is to provide a cathode catalyst layer fabricated with the aforementioned conductive composition.

A further object of the present invention is to provide a simple process for fabricating a DSC, in which a substrate is coated with the aforementioned conductive composition to prepare a counter electrode having high catalytic capacity to replace the conventional Pt electrode.

To achieve the aforementioned object, a conductive composition of the present invention comprises: PEDOT:PSS; and a surfactant having a concentration of 1-10% by weight based on a total weight of the conductive composition, wherein the conductive composition does not comprise any metal component.

In one preferred aspect of the present invention, a conductivity of the PEDOT:PSS is larger than 500 S/cm, preferably larger than 750 S/cm, and more preferably larger than 1000 S/cm.

In one preferred aspect of the present invention, the surfactant is a nonionic surfactant without any ions. Preferably, the surfactant is selected from Triton X-100, SDS or P123.

In one preferred aspect of the present invention, the aforementioned conductive composition is used to fabricate a cathode catalyst layer of a battery. Preferably, it is used to fabricate a cathode catalyst layer of a DSC.

In one preferred aspect of the present invention, a rigid substrate is used in the DSC, which is selected from an ITO glass substrate or a FTO glass substrate. Preferably, in the DSC using the rigid substrate, the concentration of the surfactant is preferably 5% by weight based on the total weight of the aforementioned conductive composition.

In one preferred aspect of the present invention, a flexible substrate is used in the DSC, which is selected from a transparent plastic substrate coated with a transparent conductive film or a metal substrate. Preferably, the transparent plastic substrate coated with the transparent conductive film is an ITO-PEN substrate, and the metal substrate is a Ti substrate, a Ni substrate or a stainless steel substrate. In addition, in the DSC using the flexible substrate, the concentration of the surfactant is preferably 3% by weight based on the total weight of the aforementioned conductive composition.

The present invention further provides a cathode catalyst layer, which is fabricated with the aforementioned conductive composition.

In addition, the present invention further provides a method for fabricating a cathode catalyst layer with the aforementioned conductive composition, which comprises the following steps: (1) providing a substrate; (2) mixing PEDOT:PSS with a surfactant to obtain a conductive composition, wherein the surfactant has a concentration of 1-10% by weight based on a total weight of the conductive composition, and the conductive composition does not comprise any metal component; (3) treating the conductive composition with an ultra-sonication process; (4) coating the substrate with the conductive composition after the ultra-sonication process; and baking the substrate coated with the conductive composition to obtain a cathode catalytic layer.

In one preferred aspect of the present invention, the substrate used in the aforementioned method is a rigid substrate selected from an ITO glass substrate or a FTO glass substrate.

In one preferred aspect of the present invention, the substrate used in the aforementioned method is a flexible substrate selected from a transparent plastic substrate coated with a transparent conductive film or a metal substrate. Preferably, the transparent plastic substrate coated with the transparent conductive film is an ITO-PEN substrate, and the metal substrate is a Ti substrate, a Ni substrate or a stainless steel substrate.

In one preferred aspect of the present invention, a weight ratio of PEDOT:PSS to the surfactant is in a range from 99:1 to 9:1.

In one preferred aspect of the present invention, the surfactant used in the aforementioned method is a nonionic surfactant without containing any ions. Preferably, the surfactant is selected from Triton X-100, SDS or P123.

In one preferred aspect of the present invention, the conductive composition is treated with the ultra-sonication process for 15 min or more in the step (3) of the aforementioned method.

In one preferred aspect of the present invention, the substrate coated with the conductive composition is baked at 90-200° C. until a dried cathode catalytic layer is obtained. Preferably, the time for the baking process is within 30 min.

In one preferred aspect of the present invention, the aforementioned method is used to fabricate a DSC.

In one preferred aspect of the present invention, the concentration of the surfactant is preferably 5% by weight based on the total weight of the aforementioned conductive composition when a rigid substrate is used to prepare the DSC in the aforementioned method.

In one preferred aspect of the present invention, the concentration of the surfactant is preferably 3% by weight based on the total weight of the aforementioned conductive composition when a flexible substrate is used to prepare the DSC in the aforementioned method.

In the method of the present invention, cheap and easily available conductive polymer PEDOT:PSS is mixed with a surfactant to obtain a conductive composition, followed by treating the obtained conductive composition with a ultra-sonication process to obtain a counter electrode of a DSC. The counter electrode prepared with the conductive composition of the present invention has high light transmittance and high catalytic capacity. Therefore, the conductive composition of the present invention can be served as an excellent material for the counter electrode of DSC.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a DSC of the present invention;

FIG. 2 shows AFM phase images of conductive compositions of the present invention, which respectively comprise (a) 0 wt %, (b) 1 wt %, (c) 3 wt % and (d) 5 wt % of Triton X-100;

FIGS. 3A-3F show Raman spectra of conductive compositions of the present invention respectively containing 0 wt %, 1 wt %, 3 wt %, 5 wt %, 7 wt % and 10 wt % of Triton X-100;

FIG. 3G shows overlapping Raman spectra of FIGS. 3A-3F;

FIG. 4A shows a cyclic voltammogram of a Pt electrode;

FIGS. 4B-4C respectively show cyclic voltammograms of counter electrodes prepared with PEDOT:PSS compositions of PH1000 and AI483095;

FIGS. 4D-4F respectively show cyclic voltammograms of counter electrodes prepared with conductive compositions of the present invention respectively containing 1 wt %, 3 wt % and 5 wt % of Triton X-100;

FIG. 4G shows overlapping cyclic voltammograms of FIGS. 4A-4C;

FIG. 4H shows overlapping cyclic voltammograms of FIGS. 4D-4F;

FIG. 5A is a perspective view showing an assembly of a symmetric cell for Electrochemical Impedance Spectroscopy (EIS) analysis;

FIG. 5B is an equivalent circuit using Pt counter electrodes;

FIG. 5C is an equivalent circuit using counter electrodes prepared with conductive compositions of the present invention containing different concentration of Triton X-100;

FIGS. 6A-6C show Nyquist diagrams of counter electrodes prepared with conductive compositions of the present invention respectively containing 1 wt %, 3 wt % and 5 wt % of Triton X-100;

FIG. 6D shows a Nyquist diagram of a Pt electrode;

FIG. 6E shows overlapping Nyquist diagrams of FIGS. 6A-6D;

FIG. 6F shows an enlarged view of overlapping Nyquist diagrams of FIGS. 6C-6D;

FIGS. 7A-7C show I-V curves of counter electrodes prepared by forming the conductive compositions respectively containing 1 wt %, 3 wt % and 5 wt % of Triton X-100 of the present invention on rigid substrates;

FIG. 7D shows an I-V curve of a Pt electrode;

FIG. 7E shows overlapping I-V curves of FIGS. 7A-7D;

FIGS. 8A-8C show I-V curves of counter electrodes prepared by forming the conductive compositions respectively containing 1 wt %, 3 wt % and 5 wt % of Triton X-100 of the present invention on flexible substrates;

FIG. 8D shows an I-V curve of a Pt electrode;

FIG. 8E shows overlapping I-V curves of FIGS. 8A-8D;

FIGS. 9A-9C show IPCE curves of counter electrodes prepared by forming the conductive compositions respectively containing 1 wt %, 3 wt % and 5 wt % of Triton X-100 of the present invention on rigid substrates;

FIG. 9D shows an IPCE curve of a Pt electrode;

FIG. 9E shows overlapping IPCE curves of FIGS. 9A-9D;

FIG. 9F shows an IPCE curve of a counter electrode prepared by forming the conductive composition containing 5 wt % of Triton X-100 of the present invention illuminated from the backside thereof;

FIG. 9G shows an IPCE curve of a Pt counter electrode illuminated from the backside thereof;

FIG. 9H shows overlapping IPCE curves of FIGS. 9F-9G;

FIGS. 10A-10C show IPCE curves of counter electrodes prepared by forming the conductive compositions respectively containing 1 wt %, 3 wt % and 5 wt % of Triton X-100 of the present invention on flexible substrates;

FIG. 10D shows an IPCE curve of a Pt electrode;

FIG. 10E shows overlapping IPCE curves of FIGS. 10A-10D;

FIG. 10F shows an IPCE curve of a counter electrode prepared by forming the conductive composition containing 3 wt % of Triton X-100 of the present invention illuminated from the backside thereof;

FIG. 10G shows an IPCE curve of a Pt counter electrode illuminated from the backside thereof;

FIG. 10H shows overlapping IPCE curves of FIGS. 10F-10G;

FIG. 11A is an equivalent circuit for Electrochemical Impedance Spectroscopy (EIS) analysis of full cells on the DSCs of the present invention;

FIG. 11B shows an EIS spectrum of a counter electrode prepared by forming the conductive composition containing 5 wt % of Triton X-100 of the present invention on a rigid substrate;

FIG. 11C shows an EIS spectrum of a Pt electrode;

FIG. 11D shows overlapping EIS spectra of FIGS. 11B-11C;

FIG. 11E shows an EIS spectrum of a counter electrode prepared by forming the conductive composition containing 3 wt % of Triton X-100 of the present invention on a flexible substrate;

FIG. 11F shows an EIS spectrum of a Pt electrode; and

FIG. 11G shows overlapping EIS spectra of FIGS. 11E-11F.

### DETAILED DESCRIPTION OF THE PREFERRED EMBODIMENT

In the present invention, the conductive composition prepared by mixing conductive polymer PEDOT:PSS with a surfactant such as Triton X-100 is used to prepare a catalyst layer of a counter electrode (i.e. cathode) of a DSC. Herein, a rigid substrate or a flexible substrate is coated with the conductive composition of the present invention after treating with an ultra-sonication process to obtain the counter electrode of the present invention. The obtained counter electrode of the present invention has higher light transmittance than the conventional Pt electrode, and therefore can be applied to interior space to absorb the indoor light. In addition, the photoelectric conversion efficiency of the obtained counter electrode of the present invention is also similar to that of the conventional Pt electrode. Hence, the conductive composition of the present invention has potential to replace the conventional Pt electrode due to the aforementioned advantages thereof.

### Preparation of the Conductive Composition and the Cathode Catalyst Layer of the Present Invention

PEDOT:PSS was mixed with Triton X-100 to obtain a composition, in which the concentration of Triton X-100 is 1 wt %, 3 wt %, 5 wt %, 7 wt % 20 and 10 wt % based on the total weight of the composition. Next, the composition was placed in an ultra-sonicator (Branson 5210) and sonicated for 15 min. A substrate (2×2 cm²) was coated with 80 μL of the composition through a two-stage spin coating process, wherein the first stage was performed under 500 rpm for 20 sec, and the second stage was performed under 800 rpm for 120 sec. After the coating process, the obtained substrate was baked at 140° C. for 10 min, and a cathode catalyst layer was obtained.

In addition, PEDOT:PSS without Triton X-100 was used to prepare a cathode catalyst layer as a comparative example. In the following embodiments, a conventional Pt electrode was also used in a comparative example, which was prepared by plating Pt on an ITO-PEN substrate with a vacuum plating machine (JEOL 1600) under 20 mA for 200 sec.

### Preparation of a Photoanode

In the present invention, two kinds of DSCs were prepared, which were respectively fabricated with a rigid substrate and a flexible substrate. In the DSC with the rigid substrate, both the photoanode and the counter electrode (i.e. cathode) were prepared with rigid substrates. In the DSC with the flexible substrate, both the photoanode and the counter electrode (i.e. cathode) were prepared with flexible substrates. Hereinafter, the preparation methods for the aforementioned two kinds of DSCs are illustrated below.

(1) Preparation of a Photoanode of a DSC with a Rigid Substrate

10 wt % ethyl cellulose (4.5 g of #46070 and 3.5 g of #46080, Fluka) alcohol solution was prepared and placed in a evaporation flask. Next, 16 g TiO₂ (P25, Degussa) and 64.9 g Terpineol (Fluka) was added therein, and alcohol was further added therein to a total volume of 280 mL. The obtained mixture was stirred with the ultra-sonicator and a stirrer for three times, and concentrated with a rotary evaporator. During the concentration process, the pressure was reduced from 120 mbar to 10 mbar when the temperature of the mixture was 40° C. The obtained mixture was applied onto an ITO glass substrate with 3-axis roller, and screen-printed for 5 times to obtain a photoanode with a thickness of 13.5 μm. Finally, the obtained substrate was heated to 450° C. to remove the redundant organic material.

The counter electrode (i.e. cathode) of the DSC with the rigid substrate was fabricated with the same process illustrated above, in which the substrate was an ITO glass substrate.

(2) Preparation of a Photoanode of a DSC with a Flexible Substrate

The photoanode with the flexible substrate was fabricated with an electrophoresis deposition. First, a suitable amount of P25 powders (Degussa) were dispersed in a water-free alcohol, followed by adding a small amount of acetyl acetone therein. The mixture was then stirred for 1 day to obtain a TiO₂ suspension. In addition, 5 mL de-ionized water, 10 mL acetone and 0.06 g I₂ was well mixed, followed by placing in the ultra-sonicator for 15 min to obtain a charged solution. Next, the TiO₂ suspension and the charged solution were mixed, followed by sonicating at low temperature for 90 min to obtain a TiO₂ electrophoresis solution. For the electrophoresis process, the ITO-PEN substrate was placed at a cathode of a DC power supply, which was departed from the anode for 1 cm. After the electrophoresis was performed under 20V for 200 sec, a photoanode with a thickness of 10.1 μm was obtained. Finally, the area of the photoanode was treated to be 4×4 mm², and heat-treated at 140° C. to remove the redundant organic material.

The counter electrode (i.e. cathode) of the DSC with the flexible substrate was fabricated with the same process illustrated above, in which the substrate was an ITO-PEN substrate.

### Assembly of DSCs of the Present Invention

In the present invention, DSCs were fabricated. The dye used therein was N719 (Solaronix), which was prepared by adding 0.05 g N719 solid into 100 mL ethanol, stirring and ultra-sonicating to obtain 5×10⁻⁴ M dye solution. The obtained dye solution was portioned and stored in dark.

The aforementioned photoanode was immersed into the N719 dye solution for about 1 day, and the dye was adsorbed on TiO₂ of the photoanode. Next, the photoanode was carefully taken out and then immersed into ethanol for 10 min to remove redundant dye aggregations. Finally, the obtained photoanode was dried for the sequential assembly process.

Herein, MPN (Alfa Aesar, 99%) was used as a solvent to prepare an electrolyte, and the prepared electrolyte comprised 0.1 M LiI (Aldrich, 99.99%), 0.05 M I₂ (Aldrich, 99.999%), 0.5 M TBP (Aldrich, 99%) and 0.6 M DMPII (Solaronix).

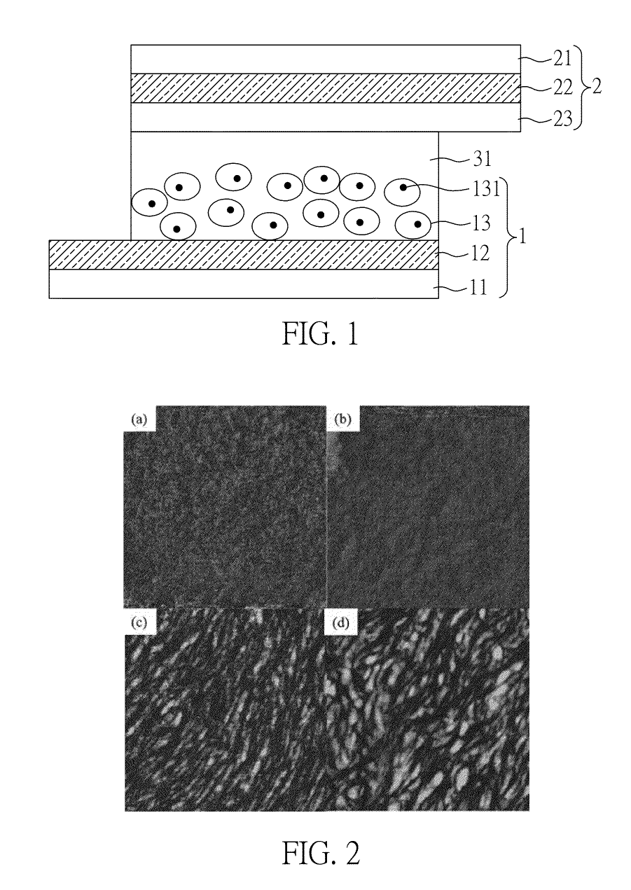

Next, a DSC was assembled. For the assembly of the DSC with the flexible substrate, a spacer (Surlyn) with a thickness of 60 m and a width of 0.6 cm was firstly placed on the substrate of the photoanode, and then the photoanode was assembled with the counter electrode. The two holes of the spacer were located on the diagonal line of the photoanode for the following electrolyte injection. After the photoanode, the spacer and the counter electrode were well aligned, assembled and fixed with a clamp, the obtained assembly was heated, and the spacer was melted to adhere the photoanode and the counter electrode. After the assembly was cooled, the electrolyte was injected therein. Finally, the holes of the spacer were sealed to prevent the electrolyte evaporating, since the leakage electrolyte which may cause the battery deteriorated. The obtained battery of the present invention is shown in FIG. 1. The assembly of the DSC with the rigid substrate was assembled through the same process illustrated above, except that a spacer with channels (Surlyn) was used. After the electrolyte was injected therein through the channels, the channels were blocked. The following embodiments are used to further illustrate the present invention, but not used to limit the content of the present invention. Although the present invention has been explained in relation to its preferred embodiment, it is to be understood that many other possible modifications and variations can be made without departing from the spirit and scope of the invention as hereinafter claimed. In addition, the whole references cited herein are incorporated herein by reference.

As shown in FIG. 1, the DSC of the present embodiment comprises: a photoanode 1; a cathode 2 opposite to the photoanode 1; and an electrolyte disposed between the photoanode 1 and the counter electrode 2. Herein, the photoanode 1 comprises: a first substrate 11 with a transparent conductive film 12 and TiO₂ particles 13 sequentially formed thereon, and dyes 131 are adsorbed onto the TiO₂ particles 13. In addition, the counter electrode 2 comprises: a second substrate 21 with a transparent conductive film 22 and a catalyst layer 23 sequentially formed thereon.

### EMBODIMENTS

### Embodiment 1

### Analysis of the Property of the Conductive Composition of the Present Invention

As illustrated above, PEDOT:PSS or the conductive composition containing PEDOT:PSS and Triton X-100 with different concentration of the present invention was respectively applied onto slide glasses, and analyzed with an atomic force microscopy (AFM), a Hall effect analyzer and a Raman analyzer.

### I. AFM Analysis

Veeco NanoMan AFM was used herein to analysis the surface structure of the specimen. The AFM comprises a probe perpendicular to the specimen, and the probe moves up and down along with the surface of the specimen. A feedback circuit controls the move of the probe along the Z axis to obtain the surface roughness of the specimen. In addition, since different material has different viscosity coefficient, the phase image detected by a tapping-mode can be used to understand the phase separation in the polymer. PSS has moisture absorption property, and is a relative soft material compared to PEDOT. Under the tapping mode, the phase angle of the soft material is relative small, which is presented in dark in the phase image; and the phase angle of the hard material is relative large, which is presented in bright in the phase image. In the present embodiment, the scanning area of the AFM was 1×1 μm².

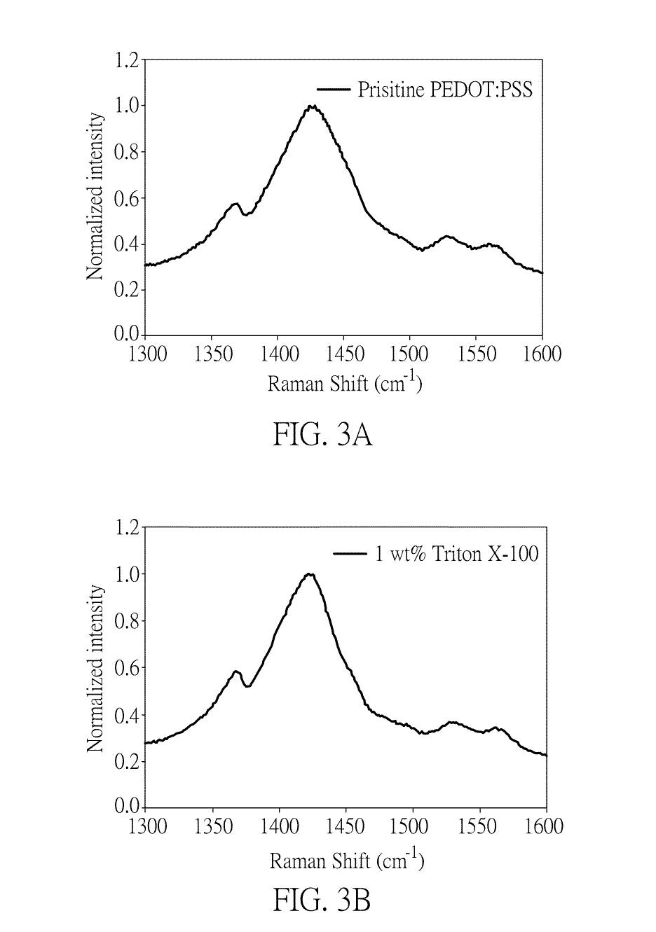

FIG. 2 shows AFM phase images of 1×1 μm² specimens observed under a tapping mode, wherein the specimens were prepared by the conductive compositions of the present invention, which respectively contain (a) 0 wt %, (b) 1 wt %, (c) 3 wt % and (d) 5 wt % of Triton X-100. The results show that Rms of each specimen is respectively 1.19 nm, 1.48 nm, 0.71 nm and 0.42 nm. Hence, as the concentration of Triton X-100 increased, a phase separation was observed between PEDOT and PPS, and especially significant in images (c) and (d) of FIG. 2. When the concentration of Triton X-100 was 5 wt %, PEDOT:PSS was aggregated to form larger particles, and the polymer chain thereof became longer. It is 25 because that the conformation of the main chain of PEDOT was changed from a coiled form into a linear or extended-coil form. This conformational change was random and not regular.

### II. Hall Effect Analysis

The Hall effect is resulted from the interaction between the electrical field and a magnetic field when charge carriers move. In general, the Hall effect is analyzed by using a sheet specimen, and the thinner specimen would be better. In addition, the applied external magnetic field is parallel to the thickness direction of the specimen. Herein, the Hall effect was analyzed in common used Van der Pauw configuration.

According to the results of the AFM analysis, the configuration of PEDOT:PSS would be changed as the amount of Triton X-100 in the conductive composition differed. According to the following Table 1, as the amount of the Triton X-100 in the conductive composition increased, the conductivity of the obtained PEDOT:PSS was enhanced. However, since the conformational change of PEDOT:PSS was random and the aggregation and the chain length of PEDOT cannot be accurately controlled, the changes in the carrier concentration and the mobility were also in random.

TABLE 1

| Triton X-100 | Conductivity | Mobility | Carrier |
|---|---|---|---|
| concentration (wt %) | (1/Ω-cm) | (cm²/V-sec) | concentration (cm⁻³) |
| 0 wt % | 3.10E−01 | 2.85E+00 | 2.28E+18 |
| 1 wt % | 9.58E+00 | 3.93E+00 | 1.50E+19 |
| 3 wt % | 2.29E+02 | 6.81E+01 | 2.10E+19 |
| 5 wt % | 3.05E+02 | 6.68E+01 | 2.85E+19 |
| 7 wt % | 3.60E+02 | 1.15E+02 | 1.95E+19 |
| 10 wt % | 5.00E+02 | 3.37E+02 | 3.06E+19 |

### III. Raman Analysis

In the present invention, the Raman spectra of the conductive compositions were observed with Renishaw Raman spectroscopy, and the laser light used therein was a 633 nm He—Ne laser.

When the incident light interacts with molecules to generate electrons, the generated electrons excite into a virtual state and then return back to a ground state. When the electrons return back to the ground state in a form of light scattering, the molecules would emit photons. If the energy of the emitted photons is not equal to that of the photons of the incident light, the Raman scattering can be observed. In the Raman spectrum, the number and the shifts of the spectral lines are related to the molecular vibration and rotation, and each molecular has its corresponding wave number (cm⁻¹). Hence, the changes in the crystallization or the bonding of a molecule can be obtained based on the Raman spectrum thereof. In the present invention, the conformational changes of PEDOT:PSS were observed by the Raman spectra thereof.

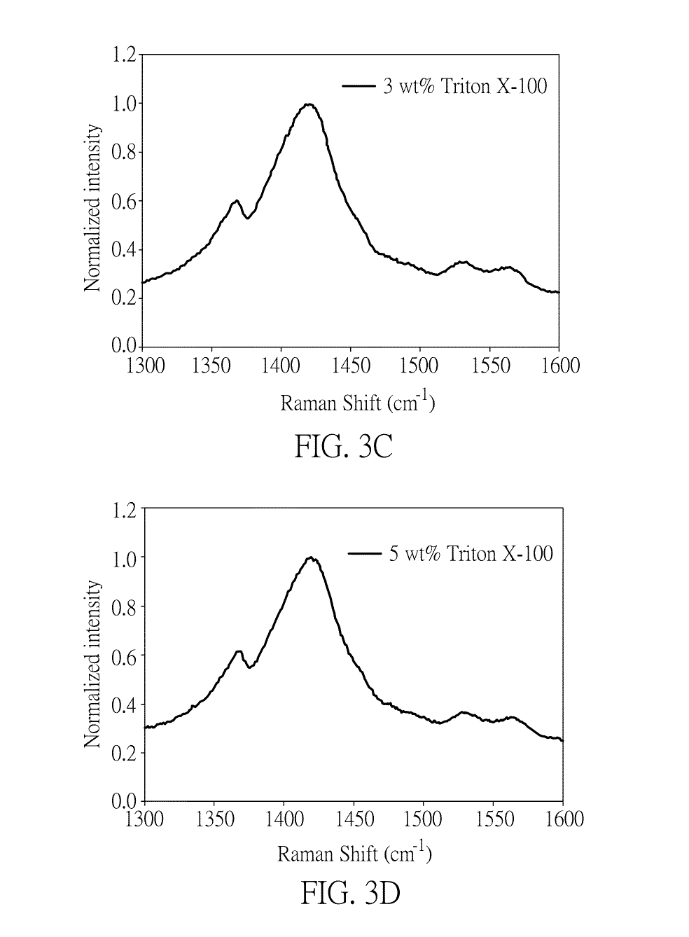

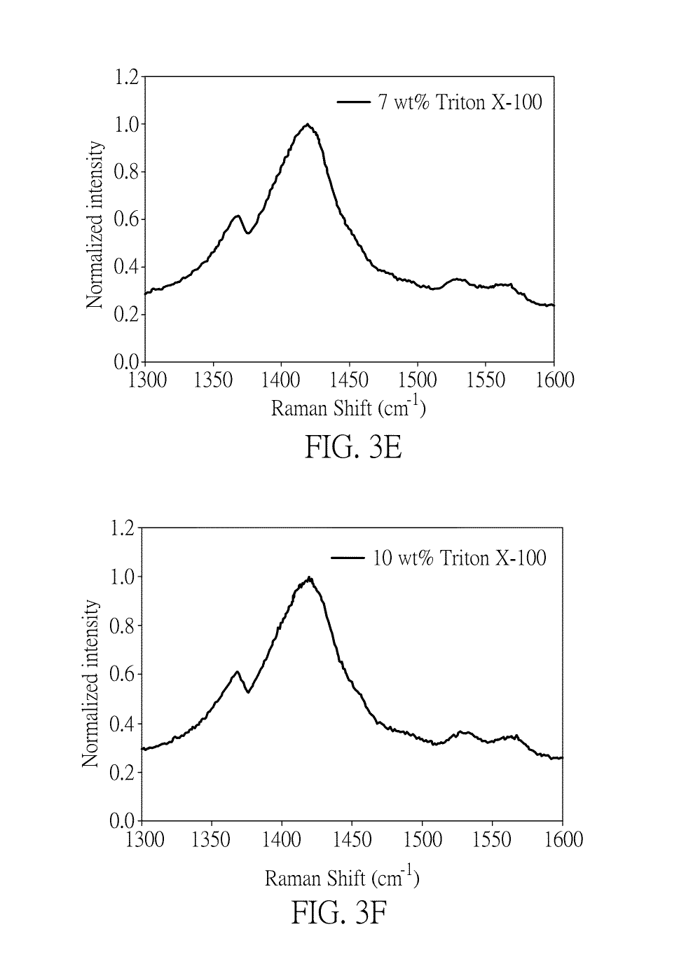

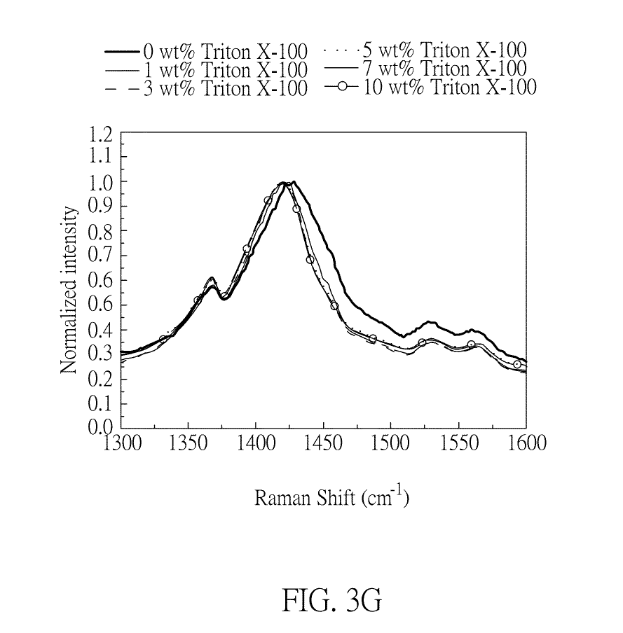

FIGS. 3A-3F show Raman spectra of conductive compositions of the present invention respectively containing 0 wt %, 1 wt %, 3 wt %, 5 wt %, 7 wt % and 10 wt % of Triton X-100; and FIG. 3G shows overlapping Raman spectra of FIGS. 3A-3F. The following Table 2 shows the positions of the main peaks of the conductive compositions containing different concentration of Triton X-100.

TABLE 2

| | Triton X-100 Concentration (wt %) | | | | | |
|---|---|---|---|---|---|---|
| | 0 | 1 | 3 | 5 | 7 | 10 |
| | wt % | wt % | wt % | wt % | wt % | wt % |
| Peak position | 1428 | 1422 | 1420 | 1419 | 1419 | 1419 |

According to the results shown in Table 2, as the concentration of Triton X-100 increased, a red shift in a range between 1400 cm⁻¹ and 1450 cm⁻¹ was observed in the Raman spectra of PEDOT:PSS, and the peak width thereof was also reduced. Herein, 1428 cm⁻¹ represents the stretching vibration of Cα=Cβ in the 5-membered thiophene ring of PEDOT. This result indicates that the conformational change of PEDOT:PSS was indeed related to the concentration of the added Triton X-100. The main chain of PEDOT was changed from the main benzoid structure into the main quinoid structure, which can be represented by the following formula.

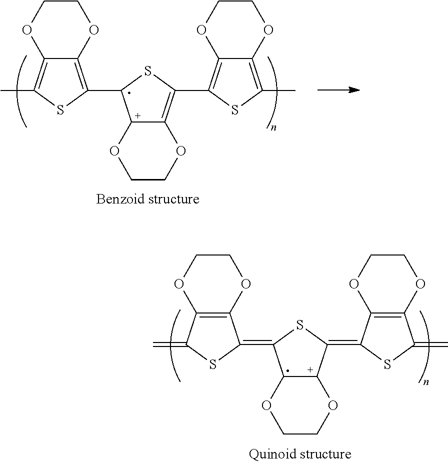

In PEDOT:PSS, both benzoid structure and quinoid structure are present. After addition of Triton X-100, the conformation of the main chain of PEDOT was changed from the spiral benzoid structure into the linear or long spiral quinoid structure. For the counter electrode (i.e. cathode) of DSC, the increased contact between the electrolyte and PEDOT having the linear or long spiral structure can facilitate the electron reduction, so that the transfer path is reduced. Hence, the addition of Triton X-100 can facilitate the catalytic capacity of the counter electrode.

### Embodiment 2

### Cyclic Voltammetry (CV) Analysis

The catalyst layer of the counter electrode (i.e. cathode) was prepared by the conductive composition of the present invention containing different concentration of Triton X-100 through the same method illustrated above. Herein, the DSCs having rigid substrates were analyzed, and the DSC with conventional counter electrode (Pt electrode) was also analyzed as a comparative embodiment.

The catalytic property of the conductive composition of the present invention was examined through cyclic voltammetry with a working electrode, a counter electrode and a reference electrode. Herein, both the counter electrode and the reference electrode were Pt electrodes, and the working electrode was the counter electrodes prepared in the present embodiment, such as the conventional Pt electrode of the comparative embodiment and the counter electrodes prepared by the conductive compositions containing different concentration of Triton X-100 of the present invention. The electrolyte used herein was an acetonitrile solution containing 10 mM I₂, 50 mM LiI and 500 mM LiClO₄, and LiClO₄ played a role for facilitating the ion transfer. The reduction potential of the counter electrode (i.e. the electrode with the catalyst layer prepared by the conductive composition of the present invention) versus the counter electrode (i.e. the Pt electrode) can be detected through the oxidation-reduction reaction of I³⁻/I⁻ in the electrolyte, which herein was presented as “Voltage vs Pt”. During the CV analysis, the scanning rate was fixed 10 mV/s, and the scanning range was began from 0.0 V to −1.2 V and returned back to 1.4 V to complete a cycle. The obtained voltage values were data relative to the reference electrode (i.e. Pt electrode)

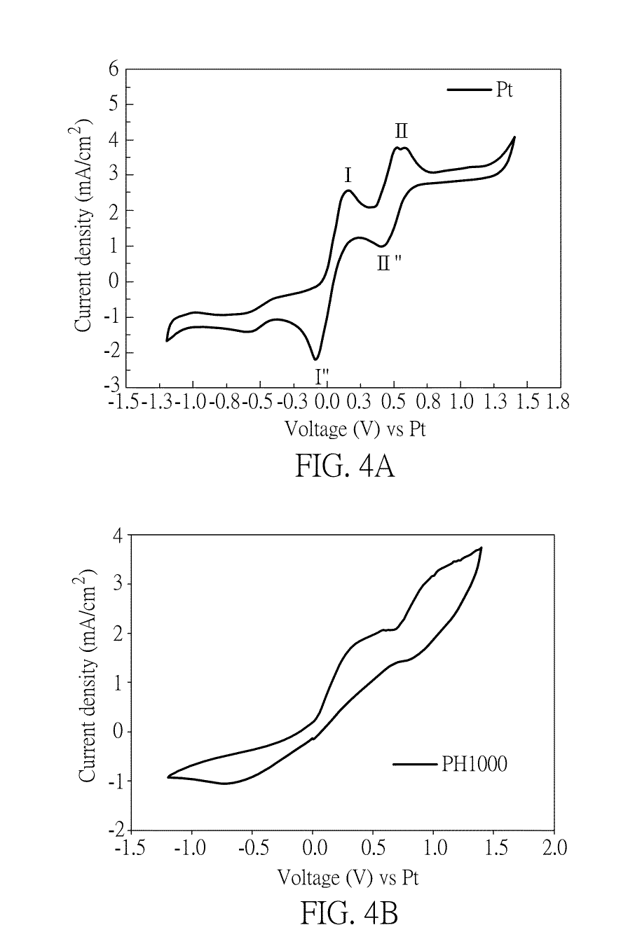

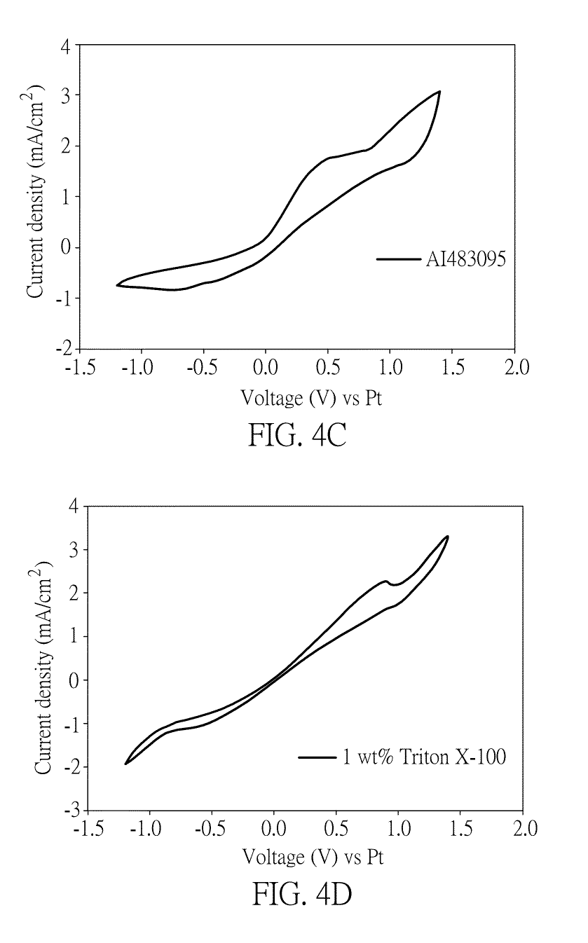

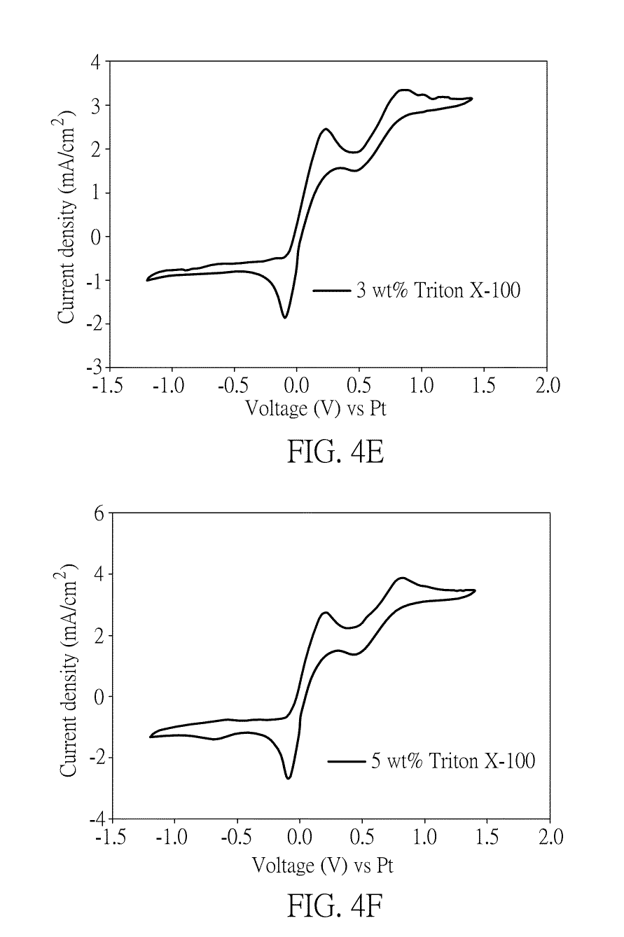

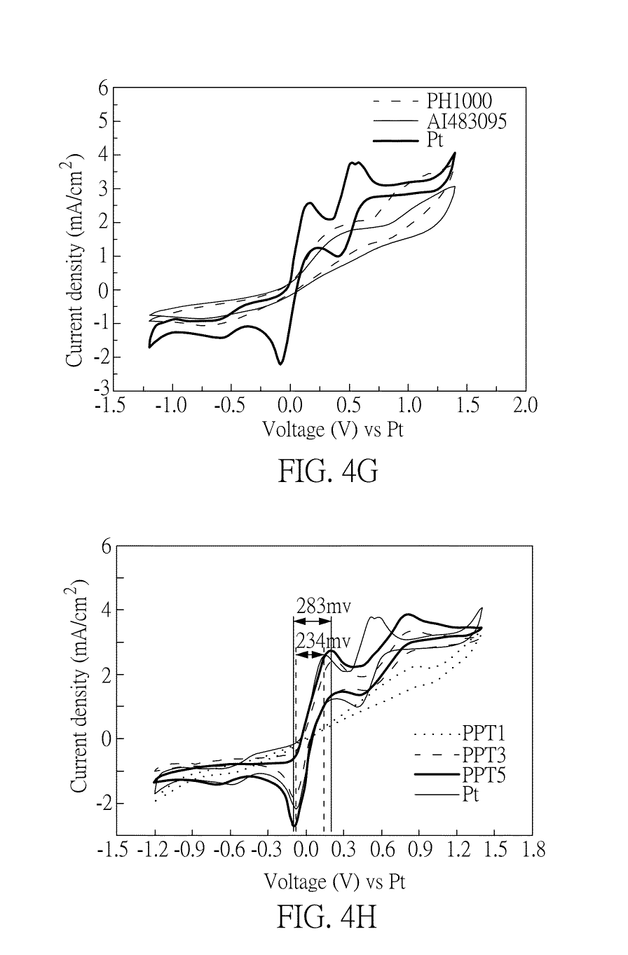

FIG. 4A shows the cyclic voltammogram of the Pt electrode as the working electrode, where I and II show the oxidation peaks, and I′ and II″ show the reduction peaks. The oxidation potential of the reaction I was about 0.153 V, and that of the reaction II was about 0.579 V. The reduction potential of the reaction I′ was about −0.081 V, and that of the reaction II′ was about 0.596 V. The difference between the peak values of the reactions I and I′ is Eₚₚ, wherein lower Eₚₚ, indicates faster reaction, and higher Eₚₚ indicates slower reaction.

3I⁻→I₃⁻+2e⁻ Reaction I:

2I₃⁻→3I₂+2e⁻ Reaction II:

I₃⁻+2e⁻→3I⁻ Reaction I′:

3I₂+2e⁻→2I₃⁻ Reaction II′:

FIGS. 4B-4C show the cyclic voltammograms of the catalyst layers prepared by PEDOT:PSS alone; and FIG. 4G shows overlapping Raman spectra of FIGS. 4A-4C. Herein, two kinds of PEDOT:PSS composition, which were respectively PH1000 (Bayer) and Al483095 (Sigma-Aldrich), were used. In the case that there was no Triton X-100 added, no oxidation peak and no reduction peak can be observed, which indicates that the photoelectric conversion efficiency of the DSCs prepared with PEDOT:PSS alone is not good enough. Hereinafter, PH1000 was used in the following experiments.

FIGS. 4D-4F show the cyclic voltammograms of the catalyst layers prepared with conductive compositions of the present invention respectively containing 1 wt % (PTT1), 3 wt % (PTT3) and 5 wt % (PTT5) of Triton X-100; and FIG. 4H shows overlapping Raman spectra of FIGS. 4D-4F. According to the aforementioned results, Eₚₚ of the Pt electrode was about 234 mV, and that of the counter electrode prepared with the conductive composition containing 5 wt % of Triton X-100 was about 283 mV.

Herein, the catalytic capacity of the counter electrodes of the DSCs prepared in the present invention was also evaluated. The conformational change of PEDOT:PSS not only improves the conductivity of the catalyst layer but also provides a more direct transfer path for electrodes transferring into the electrolyte. The current density of the reaction I′ was not significantly observed in the sample containing 1 wt % of Triton X-100, but the current density thereof was gradually increased and respectively 1.85 mA/cm² and 2.70 mA/cm² in the samples containing 3 wt % and 5 wt % of Triton X-100. It should be noted that the current density thereof in the sample containing 5 wt % of Triton X-100 was higher than that of Pt electrode, which was 2.20 mA/cm².

According to the aforementioned results, the current density of the sample containing 5 wt % of Triton X-100 is higher than that of the Pt electrode, even though Eₚₚ of the Pt electrode is lower than that of the sample containing 5 wt % of Triton X-100. Hence, the catalytic capacity of the sample containing 5 wt % of Triton X-100 is competitive with that of the Pt electrode.

### Embodiment 3

### Analysis of Electrochemical Impedance of Symmetric Cell

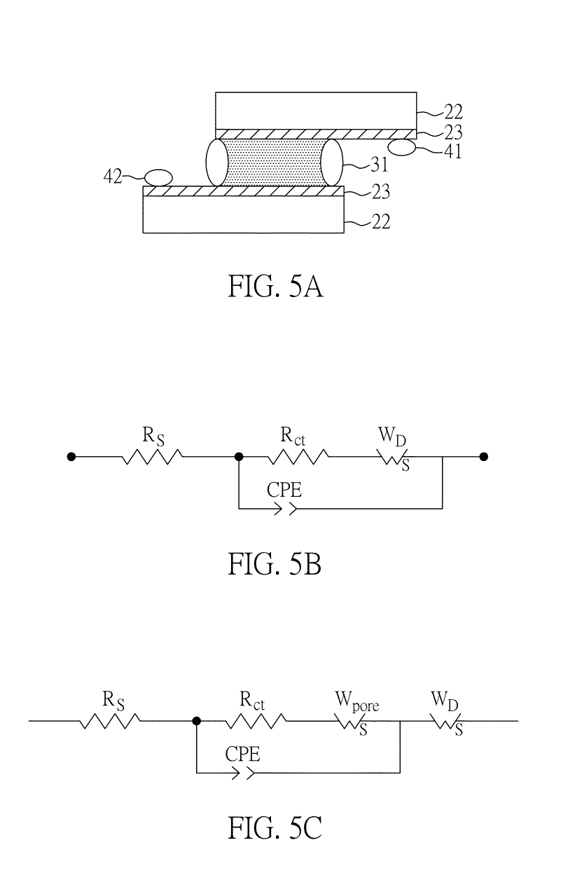

In order to understand whether the conversion efficiency of DSC is improved as the addition amount of Triton X-100 increased, Electrochemical Impedance Spectroscopy (EIS) was used to examine the impedance of electron transfer on the surface of the counter electrode. EIS analysis is a manner for measuring the steady-state of a DSC, which can be performed with a symmetric cell or a full cell. Herein, the EIS analysis was performed with the symmetric cell. As shown in FIG. 5A, a separator 31 (Surlyn) containing electrolyte was sandwiched between two counter electrodes respectively comprising a glass substrate (not shown in the figure) having a transparent conductive film 22 made of transparent conducting oxides and a catalyst layer 23 sequentially formed thereon; and terminals 41, 42 respectively connect with an external circuit. The equivalent circuit using Pt counter electrodes is shown in FIG. 5B, and that using the counter electrodes prepared with the conductive compositions containing different concentration of Triton X-100 is shown in FIG. 5C. In FIGS. 5B-5C, Rₛ represents the series resistance of the conductive glass connecting to the external circuit, R_{ct} represents the charge transfer resistance at the interface between the tested electrode and the electrolyte, W_{D} represents the diffusion resistance of I³⁻ ions in the electrolyte, and Wₚₒᵣₑ represents the Nerst diffusion resistance of I³⁻ ions in the pores of the electrode. The potential (V) and the current (I) are changed along with the frequency (f), so a corresponding impedance (Z) relation can be obtained therefrom. Hence, for the EIS analysis, the scanning frequency was from 100 kHz to 0.01 Hz, to obtain Nyquist diagram. In the present embodiment, the counter electrode prepared with the conductive compositions of the present invention formed on a rigid ITO glass substrate was examined, and the working area of the counter electrode was fixed 0.62 cm².

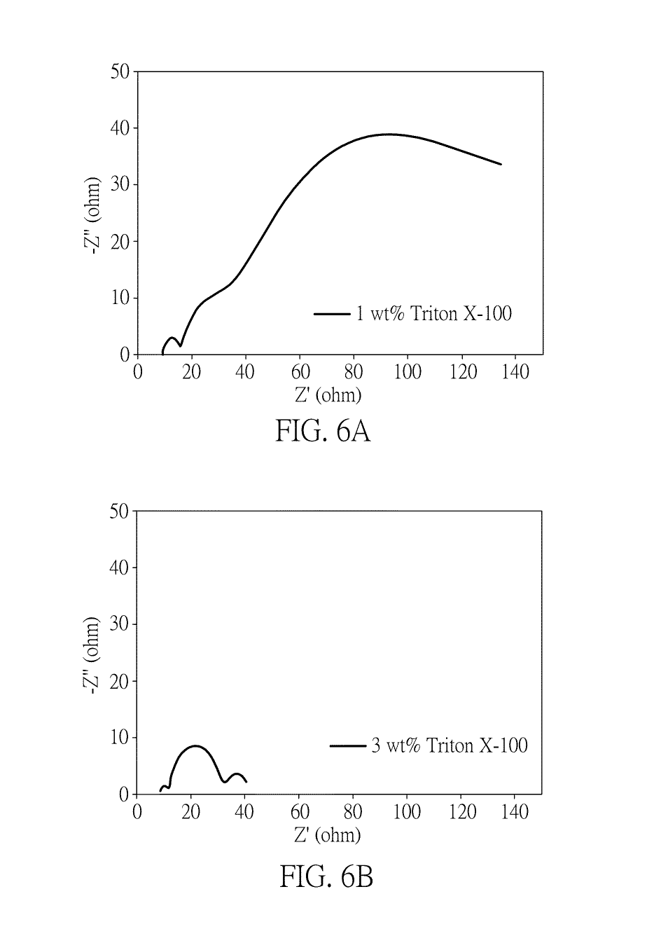

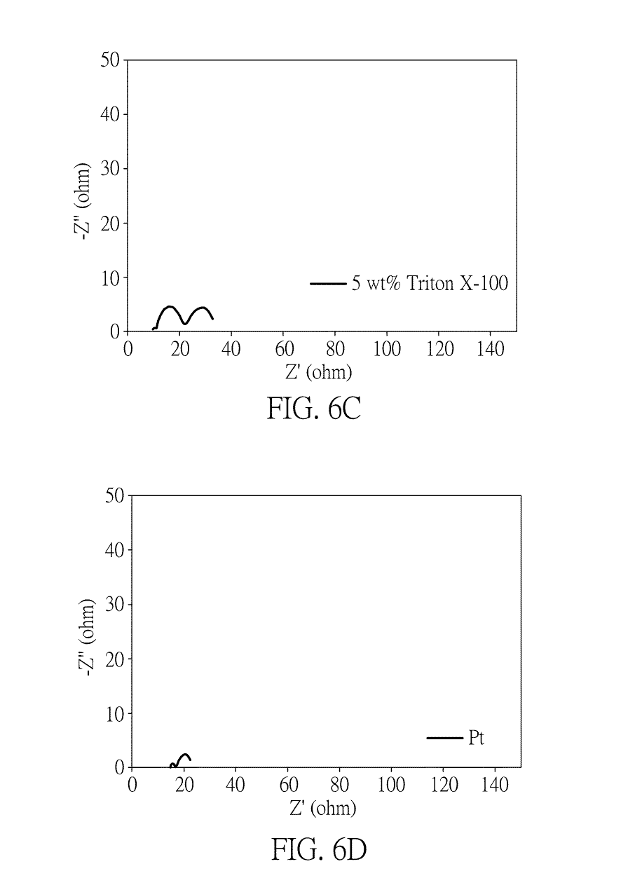

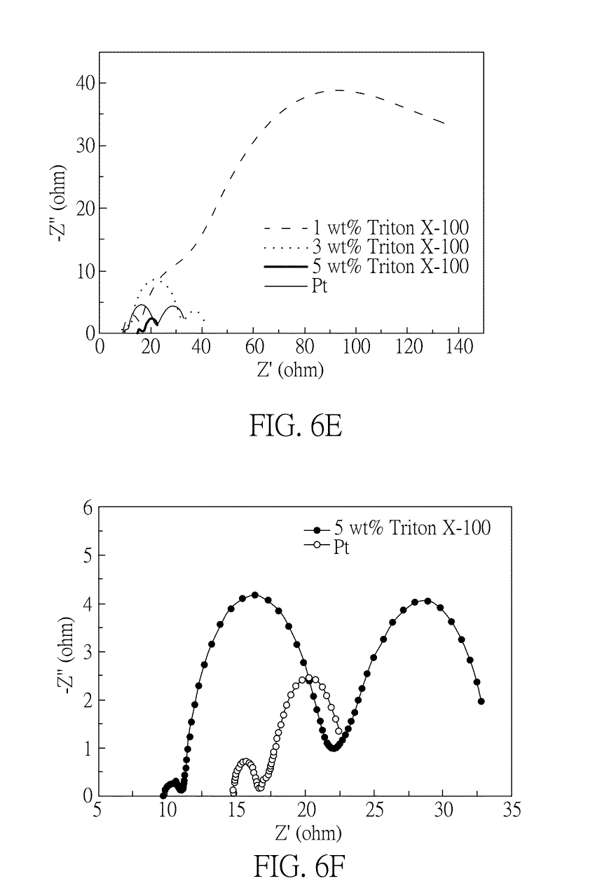

FIGS. 6A-6C show Nyquist diagrams of counter electrodes prepared with the conductive compositions of the present invention respectively containing 1 wt %, 3 wt % and 5 wt % of Triton X-100; FIG. 6D shows a Nyquist diagram of a Pt electrode; and FIG. 6E shows overlapping Nyquist diagrams of FIGS. 6A-6D. Herein, two semicircle encirclements in high and low frequency regions were observed in the Pt electrode, and three semicircle encirclements in high, middle and low frequency regions were observed in the counter electrodes prepared with the conductive compositions of the present invention. In the Nyquist diagrams of the counter electrodes prepared with the conductive compositions of the present invention, the first semicircle was observed in the high frequency region (from 2.5 kHz to 100 kHz), an intersection point of the starting position of the first semicircle and the axis was Rₛ, which represents the conductivity of the tested electrode; and the diameter of the first semicircle was R_{ct}. The second semicircle was observed in the middle frequency region (from 25 kHz to 2.5 kHz), which was resulted from the diffusion in the pores on the surface of the electrode; and this indicates that the catalytic capacity of the catalyst layers formed by the conductive compositions was not reduced even though some few defects were formed on the surface thereof. The third semicircle was observed in the low frequency region (about less than 10 Hz), and the diameter thereof was W_{D}.

According to the results shown in FIGS. 6A-6E, the charge transfer resistance (R_{ct}) was reduced as the addition amount of Triton X-100 increased. The Rₜ of the counter electrode prepared with 1 wt % of Triton X-100 was 12.19 Ωcm², that prepared with 3 wt % of Triton X-100 was 6.54 Ωcm², and that prepared with 5 wt % of Triton X-100 was 2.24 Sf cm². The reduced charge transfer resistance increases the rate of the reaction. Hence, the increased addition amount of Triton X-100 can significantly improve the catalytic property of the catalyst layer of the cathode.

FIG. 6F shows an enlarged view of overlapping Nyquist diagrams of FIGS. 6C-6D. The charge transfer resistance of the counter electrode prepared with 5 wt % of Triton X-100 (R_{ct} was 2.24 Ωcm²) was slightly less than that of the Pt electrode (R_{ct} was 3.37 Ωcm²). In addition, the conductivity Rₛ (i.e. the first intersection point of the semicircle and the X axis) of the counter electrode prepared with 5 wt % of Triton X-100 and the Pt electrode was respectively 9.7Ω and 14.7Ω. According to the results shown in the present embodiment and Embodiment 2, it can be inferred that the catalytic capacity and the charge transfer resistance of the counter electrode prepared with 5 wt % of Triton X-100 of the present invention are similar to those of the conventional Pt electrode. It is because that the addition of Triton X-100 can improve the catalytic capacity of the catalyst layer to further improve the performance of the counter electrode.

### Embodiment 4

### Analysis of Efficiency of DSC

The efficiency (η) of DSCs was measured with a standard method used in the art, wherein a solar simulator was used to evaluate the performance of the DSCs under natural sunlight illumination. The light intensity thereof used in the art is 100 mW/cm², and the following experiments were performed under this condition. In addition, a power supply was also used to provide voltage to the detected DSCs to further detect the photocurrent generated from the DSCs. Furthermore, the applied voltage was also changed to evaluate the load of the DSCs and obtain a current-voltage characteristic (i.e. I-V curve) of the DSCs. Herein, the efficiency (η) thereof was calculated from the I-V curve.

In general, conductive polymers such as PEDOT were mixed with high polar molecules such as ethylene glycol (EG) or dimethyl sulfoxide (DMSO) to improve the conductivity thereof. However, when the conductive compositions containing different concentration of Triton X-100 of the present invention were used as catalyst materials for the DSCs, the conductivity thereof cannot be significantly increased by adding high polar molecules therein (data not shown). Hence, in the following experiments, no high polar molecule was added into the conductive composition of the present invention.

I. Evaluation of the Efficiency of DSCs with Rigid Substrates

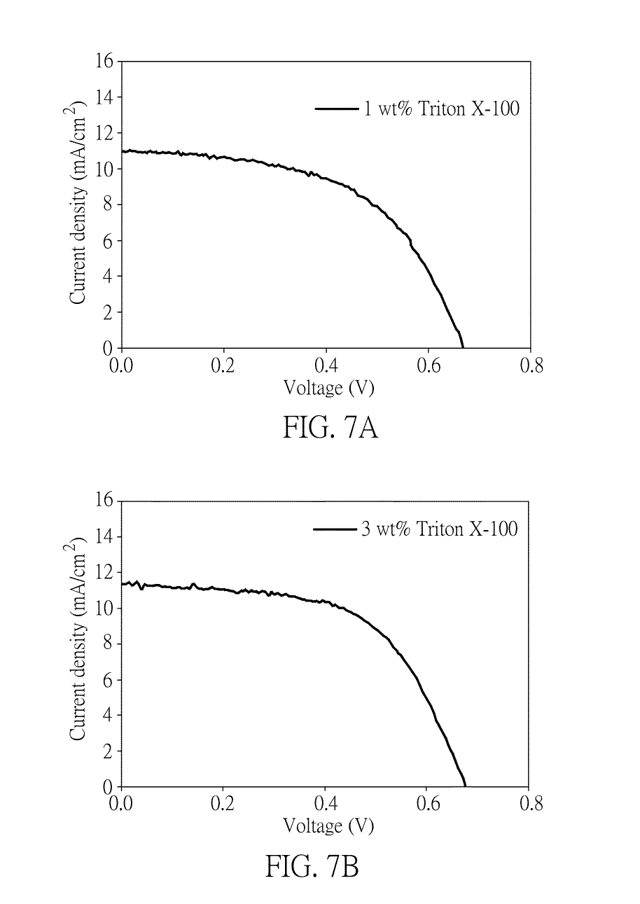

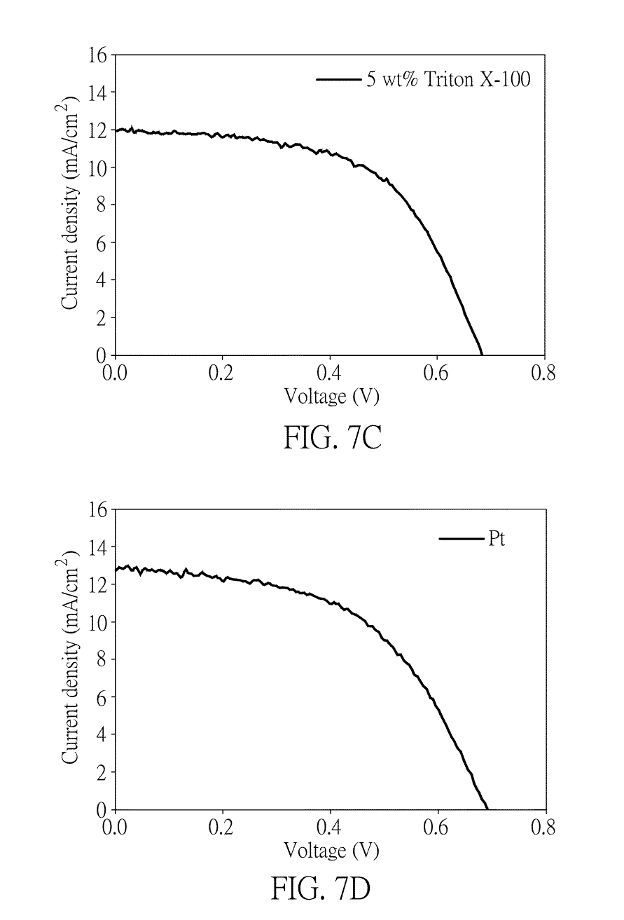

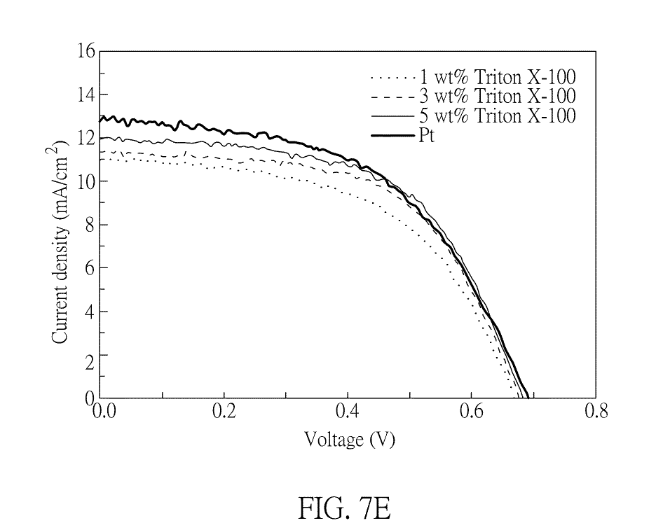

FIGS. 7A-7C show I-V curves of counter electrodes prepared by forming the conductive compositions respectively containing 1 wt %, 3 wt % and 5 wt % of Triton X-100 of the present invention on rigid substrates; FIG. 7D shows an I-V curve of a Pt electrode; and FIG. 7E shows overlapping I-V curves of FIGS. 7A-7D. In addition, the photoelectric conversion efficiency of the DSCs is listed in the following Table 3.

TABLE 3

| Counter electrode | J_{sc} (mA/cm²) | η (%) |
|---|---|---|
| Pt/ITO | 12.73 | 4.66 |
| 5 wt % Triton X-100 | 11.93 | 4.74 |
| 3 wt % Triton X-100 | 11.38 | 4.46 |
| 1 wt % Triton X-100 | 10.99 | 4.01 |

According to Table 3, when the DSCs were prepared with the rigid substrates and the conductive compositions of the present invention, the efficiency thereof was located between about 4.01% and 4.74%. In addition, when the conductive composition containing 5 wt % of Triton X-100 was used to prepare the DSC, the efficiency of the obtained DSC was about 4.74%, the open circuit voltage (V_{oc}) thereof was 0.68 V, the short circuit current density (J_{sc}) thereof was 11.93 mA/cm², and the fill factor (FF) thereof was 0.58. For the DSC with the conventional Pt electrode, the efficiency thereof was about 4.66%, the open circuit voltage (V_{oc}) thereof was 0.68 V, the short circuit current density (J_{sc}) thereof was 12.73 mA/cm², and the fill factor (FF) thereof was 0.53. Hence, the efficiency of the DSC prepared with the conductive composition containing 5 wt % of Triton X-100 of the present invention is competitive with that of the DSC having the conventional Pt electrode.

According to the results of the EIS analysis shown in Embodiment 3, when the conductive composition containing 5 wt % of Triton X-100 of the present invention was used to prepare the counter electrode, the charge transfer resistance (R_{ct}) at the interface between the counter electrode and the electrolyte was about 2.24 Ωcm², which was slightly lower than that of the Pt electrode (3.37 Ωcm²). The improved efficiency of the DSC was also attributed to the reduced R_{ct} of the conductive composition of the present invention.

Furthermore, the conformation of the main chain of PEDOT was changed into a linear or long spiral structure as the addition of Triton X-100. This conformational change facilitates the electron transfer, increases the conductivity of the conductive composition, and also improves the photoelectric conversion efficiency of the DSC.

In addition, the counter electrode prepared by applying the conductive composition containing 5 wt % of Triton X-100 of the present invention onto the rigid substrate showed excellent light transmittance. Especially, the light transmittance of the counter electrode prepared with the aforementioned composition was higher than that of the conventional Pt electrode in the visible light region with the wavelength less than about 750 nm. For example, in the visible light region with the wavelength of 550 nm, the light transmittance of the counter electrode prepared with the conductive composition containing PEDOT:PSS and 5 wt % of Triton X-100 was 93%, and that of the conventional Pt electrode was 80%. In addition, in the visible light region with the wavelength of 750 nm, the light transmittance of the counter electrode prepared with the conductive composition containing PEDOT:PSS and 5 wt % of Triton X-100 was slightly less than that of the conventional Pt electrode. When light was respectively illuminated onto the backsides of the conventional Pt electrode and the counter electrode prepared by applying the conductive composition containing 5 wt % of Triton X-100 of the present invention onto the rigid substrate, the efficiency of the obtained DSC prepared with the conductive composition of the present invention was about 3.09%, the open circuit voltage (V_{oc}) thereof was 0.62 V, the short circuit current density (J_{sc}) thereof was 6.81 mA/cm², and the fill factor (FF) thereof was 0.72; and the efficiency of the DSC with the conventional Pt electrode was about 2.19%, the open circuit voltage (V_{oc}) thereof was 0.65 V, the short circuit current density (J_{sc}) thereof was 5.56 mA/cm², and the fill factor (FF) thereof was 0.60. This result indicates that the efficiency of the back-side illuminated DSC prepared with the conductive composition containing 5 wt % of Triton X-100 of the present invention has better efficiency than that of the back-side illuminated DSC with the conventional Pt electrode.

In addition, two PEDOT:PSS layers were formed on the rigid substrate through a spin-coating process to increase the thickness of the catalyst layer. After the DSC having two PEDOT:PSS layers as a catalyst layer was evaluated by the aforementioned analysis, it is found that the performance thereof was not significantly increased, but the light transmittance of the counter electrode was reduced. Hence, it is not suggested to increase the thickness of the catalyst layer.

II. Evaluation of the Efficiency of DSCs with Flexible Substrates

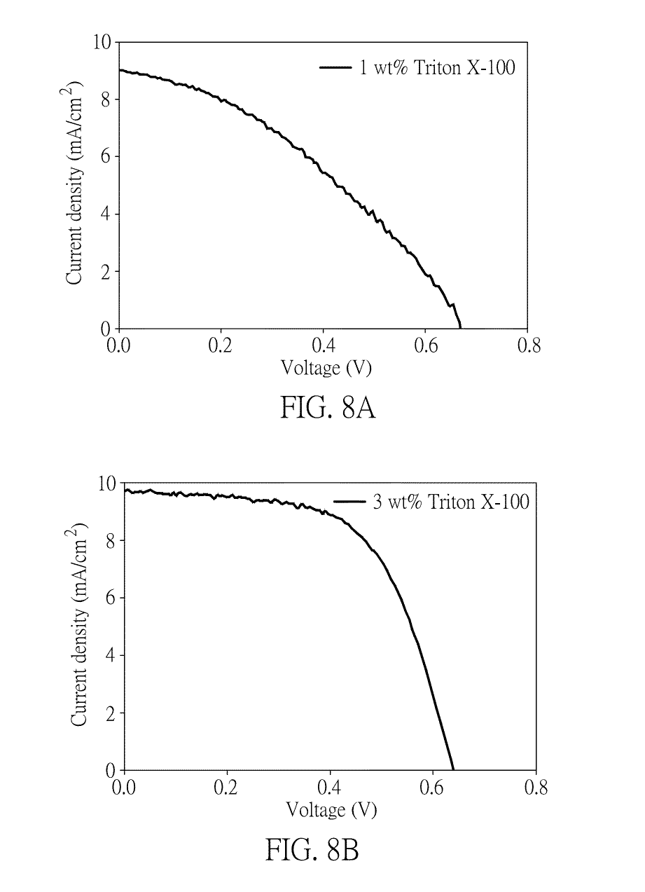

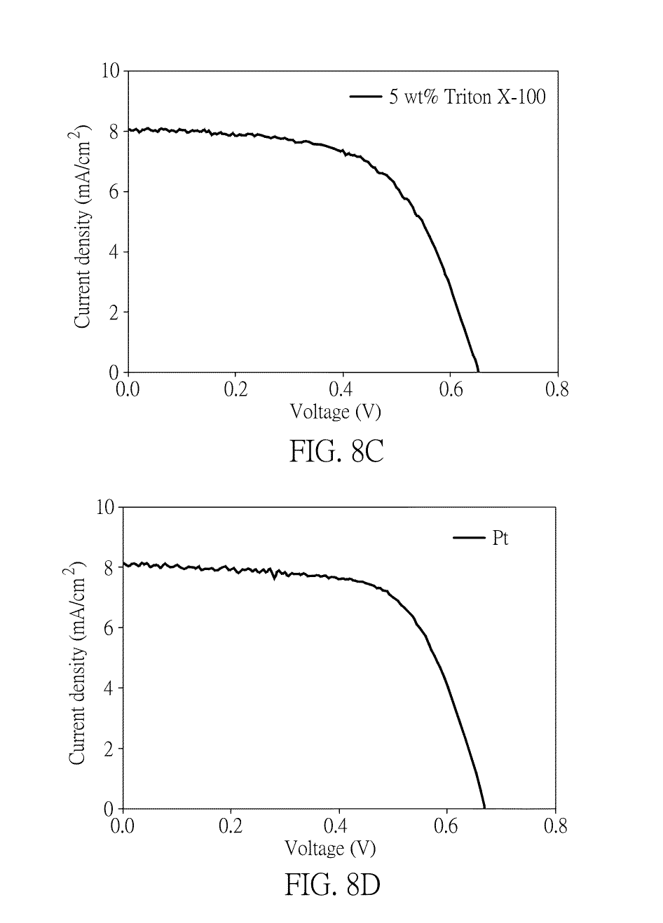

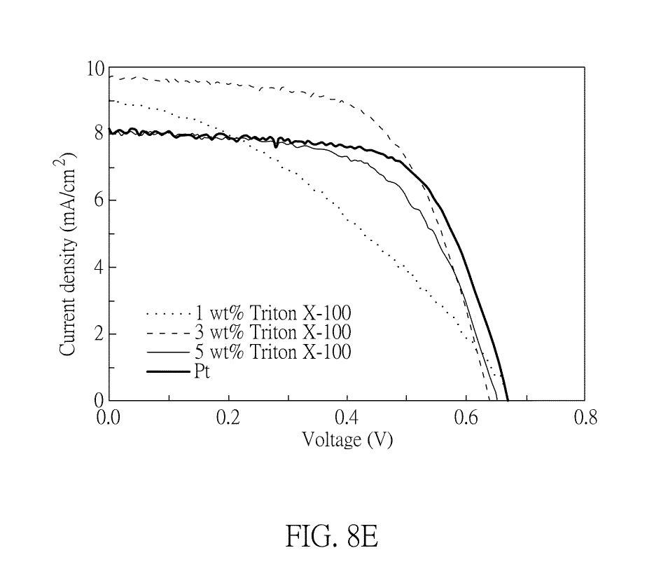

FIGS. 8A-8C show I-V curves of counter electrodes prepared by forming the conductive compositions respectively containing 1 wt %, 3 wt % and 5 wt % of Triton X-100 of the present invention on flexible substrates; FIG. 8D shows an I-V curve of a Pt electrode; and FIG. 8E shows overlapping I-V curves of FIGS. 8A-8D. In addition, the photoelectric conversion efficiency of the DSCs is listed in the following Table 4.

TABLE 4

| Counter electrode | J_{sc} (mA/cm²) | η (%) |
|---|---|---|
| Pt | 8.14 | 3.52 |
| 5 wt % Triton X-100 | 8.06 | 3.36 |
| 3 wt % Triton X-100 | 9.73 | 3.74 |
| 1 wt % Triton X-100 | 9.01 | 2.58 |

According to Table 4, when the DSCs were prepared with the flexible substrates and the conductive compositions of the present invention, the efficiency thereof was located between about 2.58% and 3.74%. In addition, when the conductive composition containing 3 wt % of Triton X-100 was used to prepare the DSC, the efficiency of the obtained DSC was about 3.74%, the open circuit voltage (V_{oc}) thereof was 0.64 V, the short circuit current density (J_{sc}) thereof was 9.73 mA/cm², and the fill factor (FF) thereof was 0.60. For the DSC with the conventional Pt electrode, the efficiency thereof was about 3.52%, the open circuit voltage (V_{oc}) thereof was 0.67 V, the short circuit current density (J_{sc}) thereof was 8.14 mA/cm², and the fill factor (FF) thereof was 0.64. Hence, the DSC prepared with the conductive composition containing 3 wt % of Triton X-100 of the present invention has the best efficiency. This result indicates that the performance of the DSC is related to the used substrate.

In addition, when light was respectively illuminated onto the backsides of the conventional Pt electrode and the counter electrode prepared by applying the conductive composition containing 3 wt % of Triton X-100 of the present invention onto the flexible substrate, the efficiency of the obtained DSC prepared with the conductive composition of the present invention was about 1.66%, the open circuit voltage (V_{oc}) thereof was 0.61 V, the short circuit current density (J_{sc}) thereof was 4.12 mA/cm², and the fill factor (FF) thereof was 0.65; and the efficiency of the DSC with the conventional Pt electrode was about 1.24%, the open circuit voltage (V_{oc}) thereof was 0.62 V, the short circuit current density (J_{sc}) thereof was 3.05 mA/cm², and the fill factor (FF) thereof was 0.65. This result indicates that the efficiency of the back-side illuminated DSC prepared with the conductive composition containing 3 wt % of Triton X-100 of the present invention has better efficiency than that of the back-side illuminated DSC with the conventional Pt electrode.

### Embodiment 5

### Analysis of Incident Photon-to-Electron Conversion Efficiency

Incident photon-to-electron conversion efficiency (IPCE) is the quantum efficiency (QE) that photos convert into electrons in the DSC at a specific wavelength. In general, QE refers to external quantum efficiency (EQE), where charge carriers move into an external circuit after incident light illuminates into the DSC. Hence, the loss caused by the reflection of incident photos at the incident surface is not taken into considered.

In the present embodiment, an IQE-200 quantum efficiency measurement system was used to detect the IPCE of the DSC. Herein, the analysis was performed in a DC mode. A continuous spectrum of all the wavelength was provided and split into monochromatic light with different wavelength through a monochromator, the obtained monochromatic light was collected with lenses and reflection mirrors, the collected light was illuminated into the DSC, and then the photocurrent generated from the DSC was measured. Herein, QE-R3011 system provided by Enlitech was used herein to measure the quantum efficiency.

I. Analysis of Incident Photon-to-Electron Conversion Efficiency of DSCs with Rigid Substrates

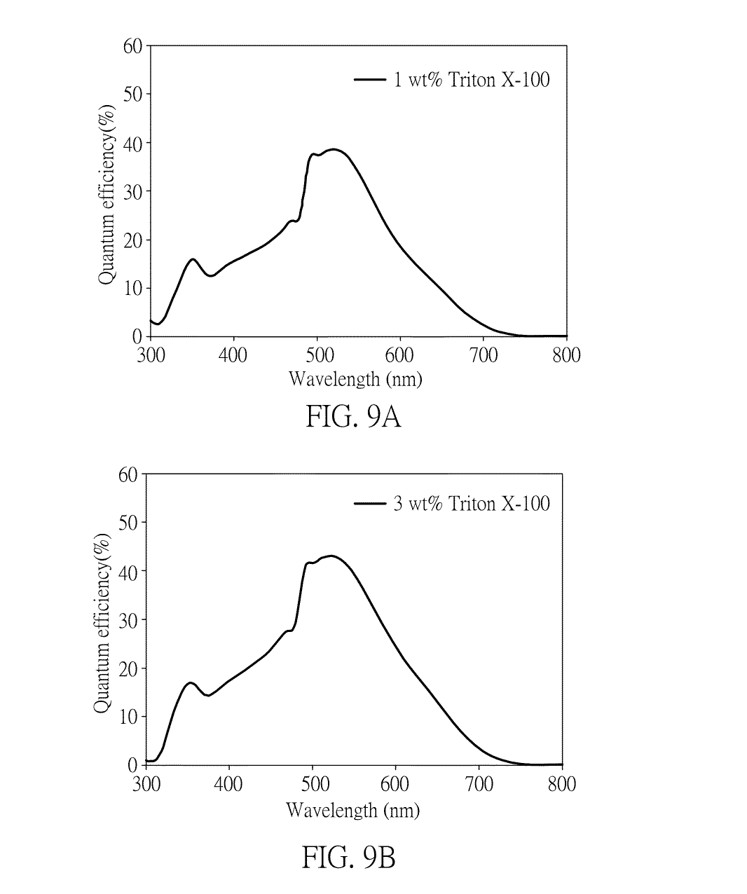

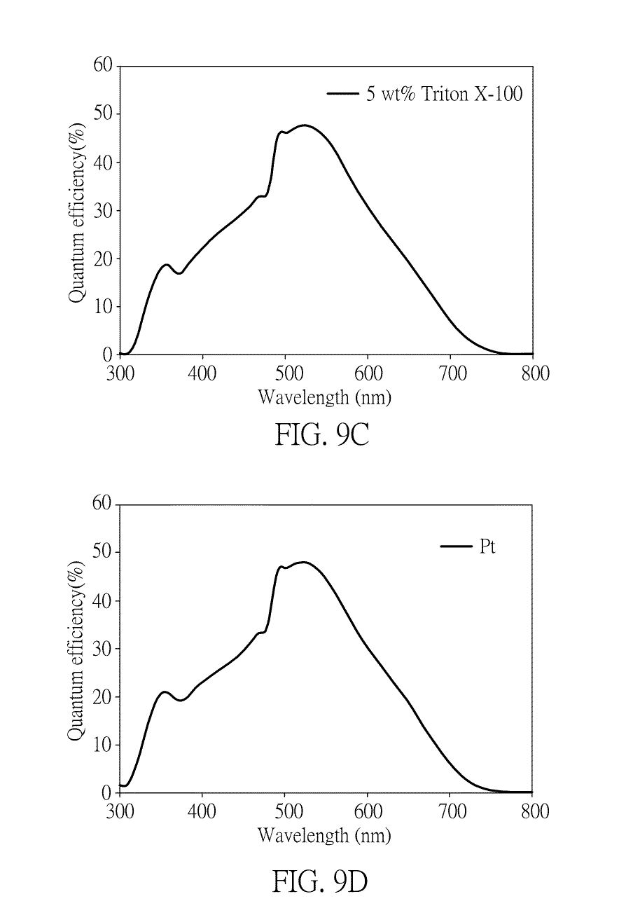

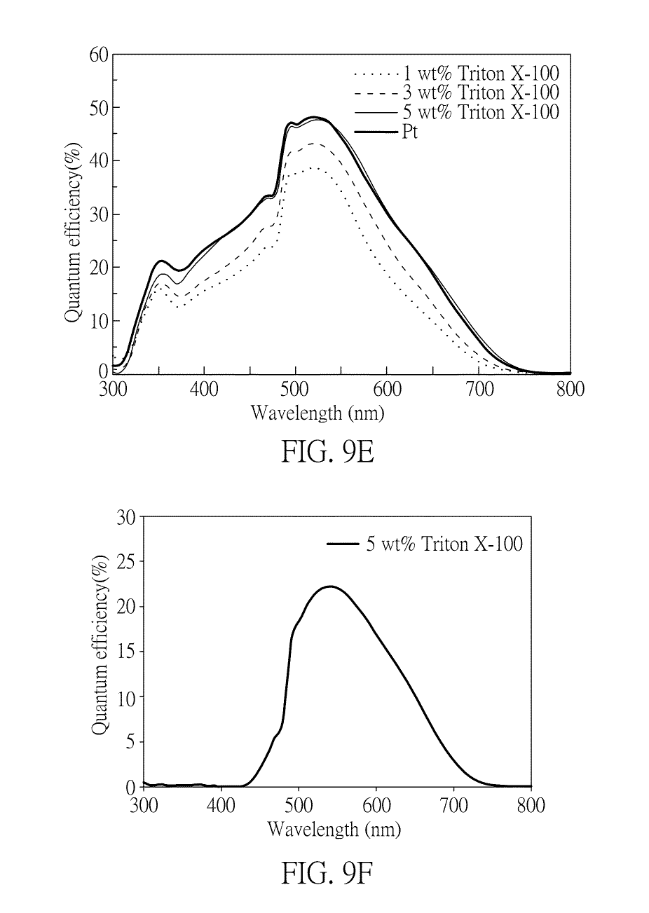

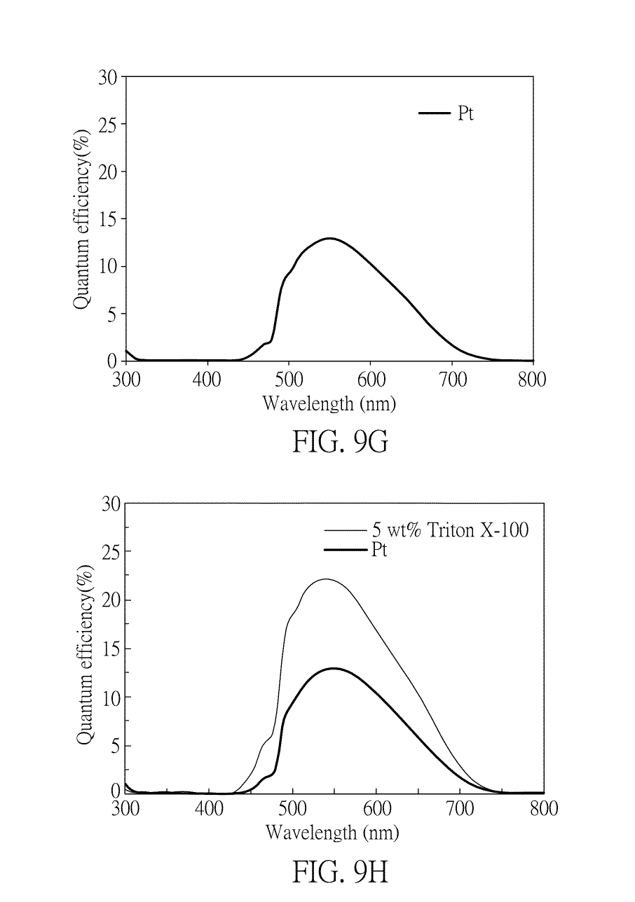

FIGS. 9A-9C show IPCE curves of counter electrodes prepared by forming the conductive compositions respectively containing 1 wt %, 3 wt % and 5 wt % of Triton X-100 of the present invention on rigid substrates; FIG. 9D shows an IPCE curve of a Pt electrode; and FIG. 9E shows overlapping IPCE curves of FIGS. 9A-9D. The IPCE was measured at a short circuit condition, which indicates the short circuit current of the DSC. Hence, the tendency thereof is similar to that of the short circuit current density (J_{sc}) shown in Table 3. At a wavelength rage of 400 nm˜550 nm, the improvement of the quantum efficiency corresponded with the light absorption of the used dye N719 in the DSC of the present invention. According to the results shown in FIGS. 9A-9E, the IPCE of the counter electrode prepared with the conductive composition containing 5 wt % of Triton X-100 of the present invention was similar to that of the Pt counter electrode, wherein the average quantum efficiency of the counter electrode of the present invention was 21.4%, and that of the Pt counter electrode was 21.4%.

The IPCE of the back-side illuminated DSCs was also detected, as shown in Embodiment 4. FIG. 9F shows an IPCE curve of a counter electrode prepared by forming the conductive composition containing 5 wt % of Triton X-100 of the present invention illuminated from the backside thereof; FIG. 9G shows an IPCE curve of a Pt counter electrode illuminated from the backside thereof; and FIG. 9H shows overlapping IPCE curves of FIGS. 9F-9G. Since the light transmittance of the counter electrode prepared by forming the conductive composition containing 5 wt % of Triton X-100 of the present invention on the rigid substrate is higher than that of the Pt counter electrode, so the photos illuminated into the counter electrode of the present invention is more than those illuminated into the Pt counter electrode. Hence, the IPCE of the counter electrode of the present invention was 10% more than that of the Pt counter electrode, and the tendency thereof is similar to that of the short circuit current density (J_{sc}). Therefore, when the conductive composition containing 5 wt % of Triton X-100 of the present invention was applied onto a rigid substrate, an excellent counter electrode can be obtained.

II. Analysis of Incident Photon-to-Electron Conversion Efficiency of DSCs with Flexible Substrates

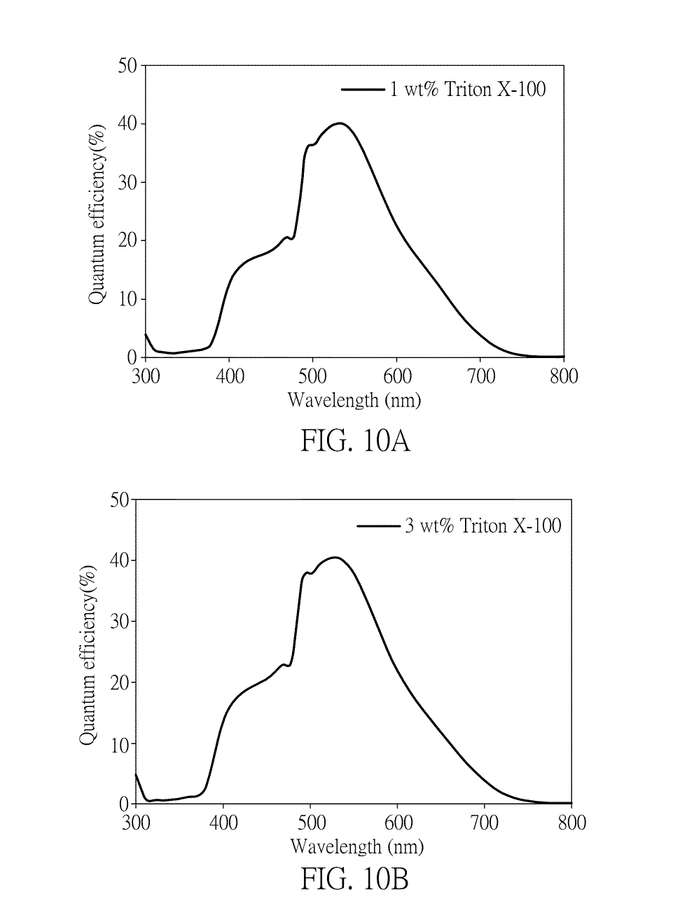

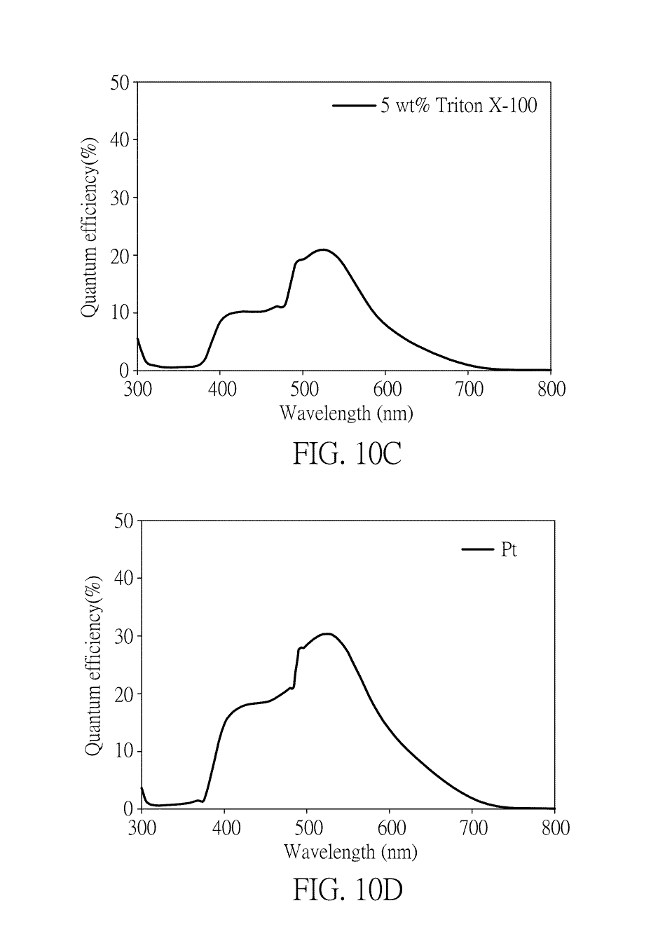

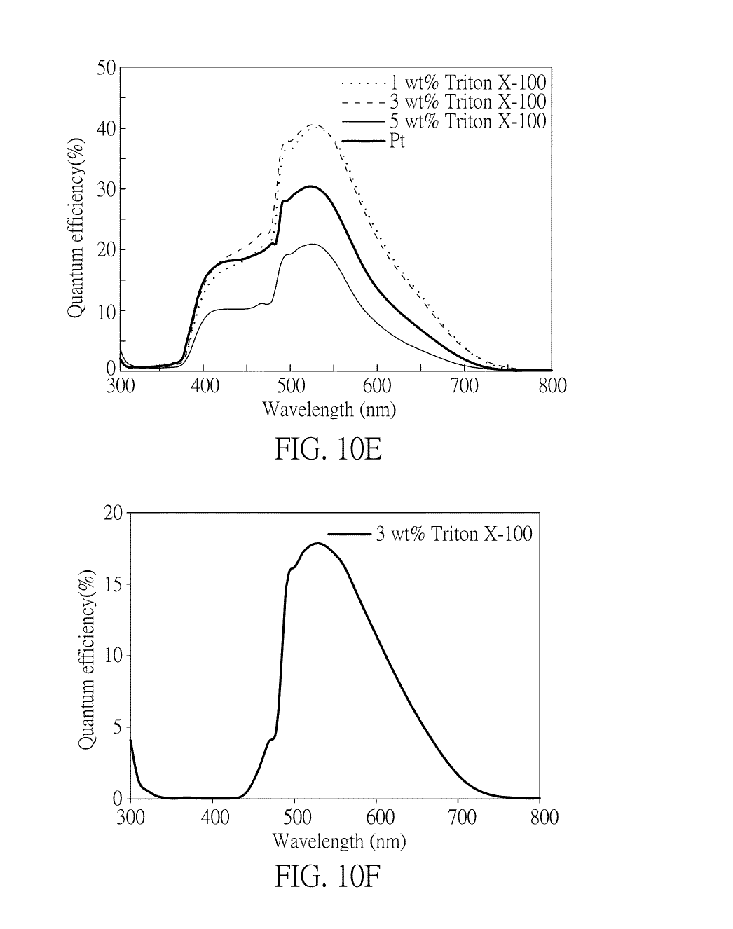

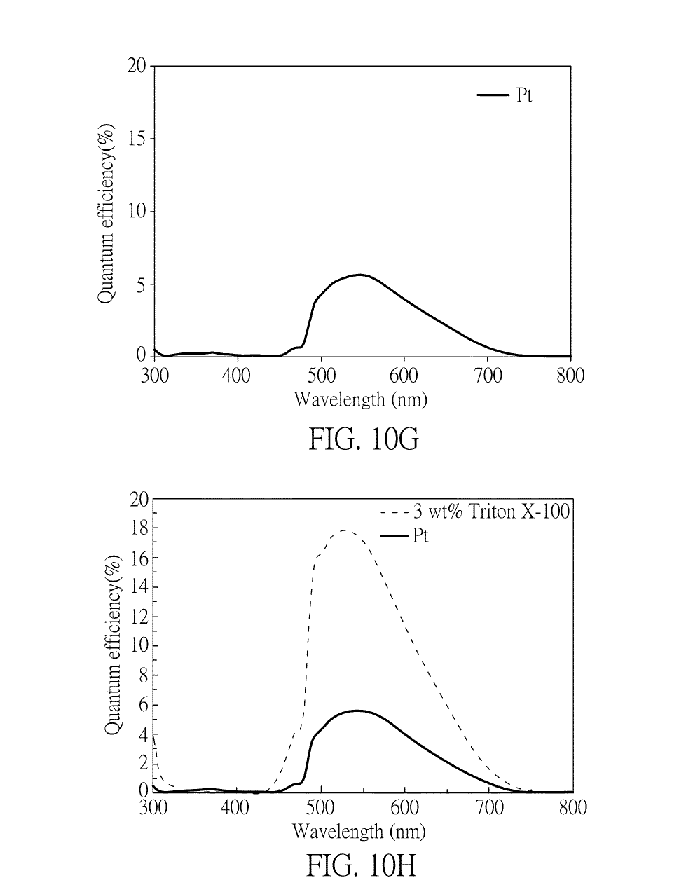

FIGS. 10A-10C show IPCE curves of counter electrodes prepared by forming the conductive compositions respectively containing 1 wt %, 3 wt % and 5 wt % of Triton X-100 of the present invention on flexible substrates; FIG. 10D shows an IPCE curve of a Pt electrode; and FIG. 10E shows overlapping IPCE curves of FIGS. 10A-10 D. As shown in Table 4, the tendency of IPCE is similar to that of the short circuit current density (J_{sc}). However, when the conductive composition of the present invention was applied onto a flexible substrate, the IPCE of the counter electrode prepared with the conductive composition containing 5 wt % of Triton X-100 of the present invention was 10% less than that of the Pt counter electrode. It is because a great conformational change of the conductive composition containing 5 wt % of Triton X-100 of the present invention was occurred after it was applied onto a flexible ITO-PEN substrate and contacted with the electrolyte; and this great conformational change may cause the efficiency of the DSC degraded. At a wavelength rage of 400 nm˜550 nm, the improvement of the quantum efficiency corresponded with the light absorption of the used dye N719 in the DSC of the present invention. In addition, according to the results shown in FIGS. 10A-10E, the IPCE of the counter electrode prepared with the conductive composition containing 5 wt % of Triton X-100 of the present invention was 10% higher than that of the Pt counter electrode, wherein the average quantum efficiency of the counter electrode of the present invention was 14.6%, and that of the Pt counter electrode was 11.1%.

The IPCE of the back-side illuminated DSCs was also detected, as shown in Embodiment 4. FIG. 10F shows an IPCE curve of a counter electrode prepared by forming the conductive composition containing 3 wt % of Triton X-100 of the present invention illuminated from the backside thereof; FIG. 10G shows an IPCE curve of a Pt counter electrode illuminated from the backside thereof; and FIG. 10H shows overlapping IPCE curves of FIGS. 10F-10G. Since the light transmittance of the counter electrode prepared by forming the conductive composition containing 3 wt % of Triton X-100 of the present invention on the flexible substrate is higher than that of the Pt counter electrode, so the photos illuminated into the counter electrode of the present invention is more than those illuminated into the Pt counter electrode. Hence, the IPCE of the counter electrode of the present invention was 10% more than that of the Pt counter electrode, and the tendency thereof is similar to that of the short circuit current density (J_{sc}). Therefore, when the conductive composition containing 3 wt % of Triton X-100 of the present invention was applied onto a flexible substrate, an excellent counter electrode can be obtained.

### Embodiment 6

### Analysis of Electrochemical Impedance Spectroscopy of Full Cells

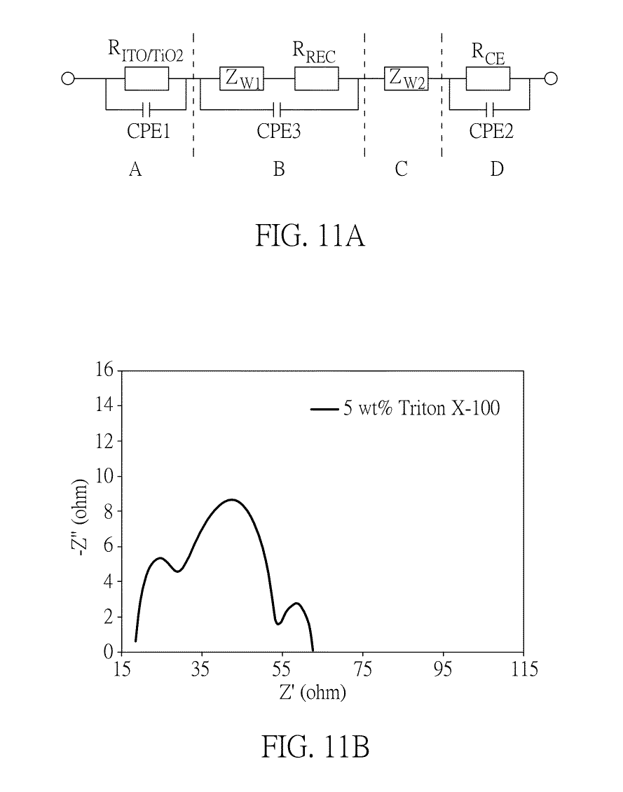

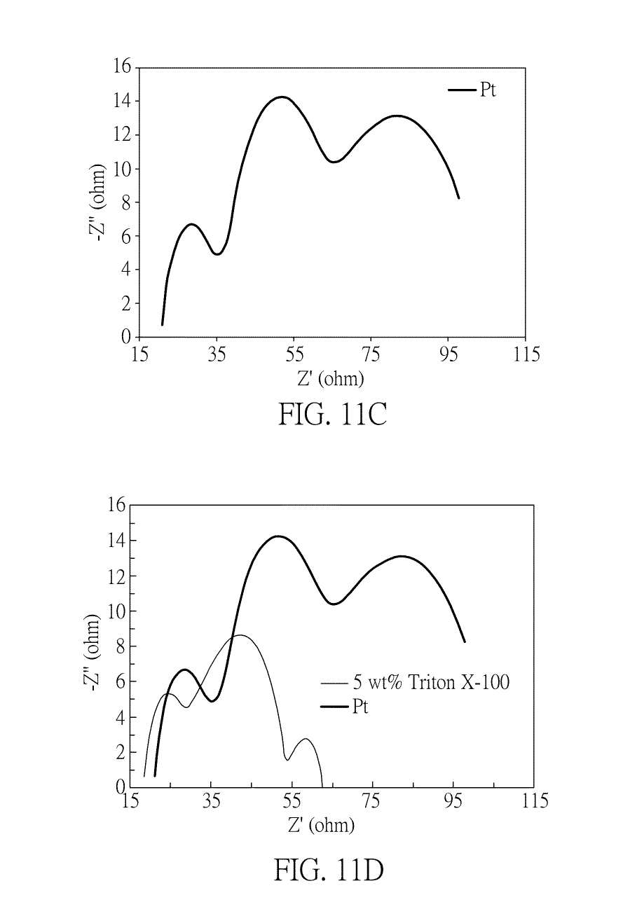

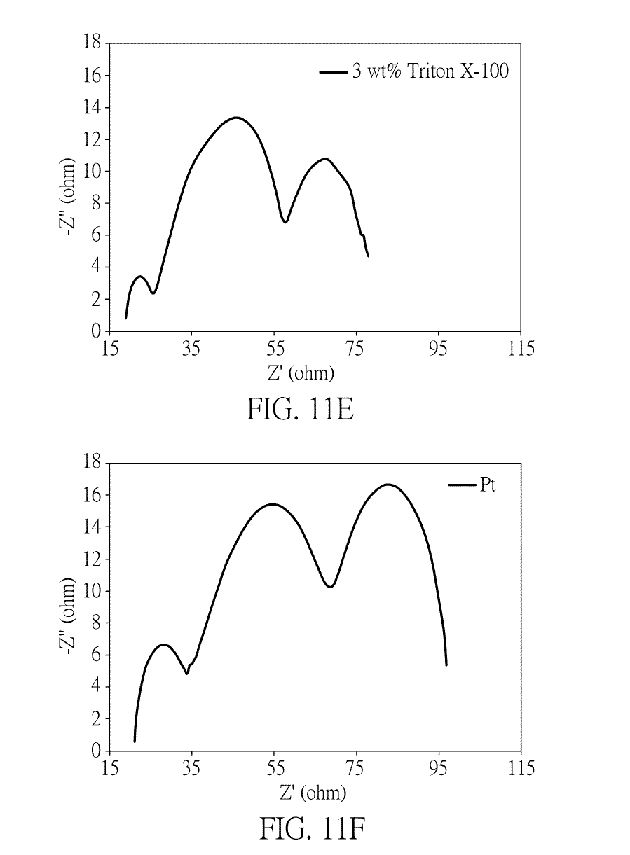

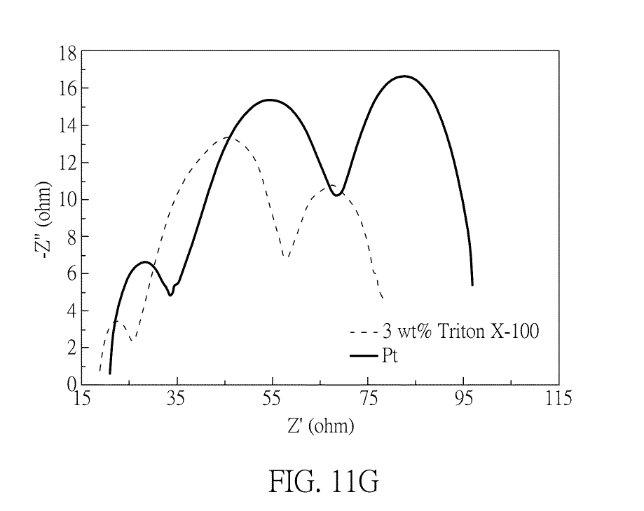

In the present invention, Electrochemical Impedance Spectroscopy (EIS) analysis of full cells on the DSCs of the present invention was performed. The equivalent circuit thereof is shown in FIG. 11A, wherein R represents the resistance, in which R_{FTO/TiO2} refers to the resistance at the interface between the FTO conductive layer on the substrate and TiO₂, RREC refers to the transfer resistance series connected to Z_{W1}, and R_{CE} refers the charge transfer resistance of the counter electrode; CPE represents the capacitance, in which CPE1 refers to the capacitance at the interface between the FTO conductive layer on the substrate and TiO₂, CPE2 refers to the electrical double layer capacitance, and CPE3 refers to the capacitance parallel connected to Z_{W1} and R_{REC} in the same phase; and Z_{W} represents the diffusion resistance of I³⁻ ions in the electrolyte, in which Z_{W1} refers to the diffusion resistance of the equivalent circuit of porous TiO₂ thin film, and Z_{W2} refers to the diffusion resistance of I³⁻ ions in the electrolyte. In addition, the equivalent circuit shown in FIG. 11A can be divided into four regions, the region A indicates the transfer resistance at the interface of ITO/TiO₂, the region B indicates the resistance when electrons transfer at the interface of TiO₂/electrolyte and reverse reaction occurred, the region C indicates the diffusion resistance of I³⁻ ions in the electrolyte, and the region D can be used to obtain the EIS of the DSCs of the present invention. Herein, after the transfer resistance of the electrolyte/Pt-ITO interface was assembled, an interface reaction of the cell under a standard light source (100 mW/cm²) was measured with a Frequency response analyzer (FRA) to obtain the EIS of the DSCs of the present invention, wherein a potential identical to the open circuit voltage was applied thereto, the scanning altitude was fixed 10 mV, and the scanning rage was from 0.05 Hz to 105 Hz.

I. Analysis of EIS of DSCs with Rigid Substrates

FIG. 11B shows an EIS spectrum of a counter electrode prepared by forming the conductive composition containing 5 wt % of Triton X-100 of the present invention on a rigid substrate; FIG. 11C shows an EIS spectrum of a Pt electrode; and FIG. 11D shows overlapping EIS spectra of FIGS. 11B-11C. Three semicircle encirclements were observed in both the two specimens from high frequency to low frequency. The left semicircle in the high frequency region indicates the transfer resistance between the electrolyte and the counter electrode. The middle semicircle in the middle frequency region indicates the resistance of the transfer and recombination between TiO₂ and the electrolyte. The right semicircle in the low frequency region indicates that the resistance of Nernst diffusion of I³⁻ in the electrolyte. The diameter of the semicircle in the high frequency region is R_{ct}, which represents the catalytic capacity of the electrode. According to the results shown in FIGS. 11B-11D, the catalytic capacity of the counter electrode prepared with the conductive composition containing 5 wt % of Triton X-100 of the present invention was similar to that of the Pt counter electrode.

II. Analysis of EIS of DSCs with Flexible Substrates

FIG. 11E shows an EIS spectrum of a counter electrode prepared by forming the conductive composition containing 3 wt % of Triton X-100 of the present invention on a flexible substrate; FIG. 11F shows an EIS spectrum of a Pt electrode; and FIG. 11G shows overlapping EIS spectra of FIGS. 11E-11F. According to the diameter of the semicircle in the high frequency region (R_{ct}), the counter electrode with improved catalytic capacity can be obtained by using the conductive composition containing 3 wt % of Triton X-100 of the present invention.

### Embodiment 7

### IMPS Analysis

Intensity Modulated Photocurrent Spectroscopy (IMPS) is one device to detect the electron transfer inside the DSCs. A slight vibrated light is illuminated onto the photoanode of the DSC at a constant voltage, and then a vibrated alternating current was generated from the DSC. A delayed photocurrent and a photovoltage response can be obtained by changing the frequency of the light source, thereby to obtain the IMPS spectrum, which can be used to calculate the electron diffusion time (τ_{d}).

I. Analysis of IMPS Spectra of DSCs with Rigid Substrates

Since the thickness of the photoanode of the DSC with the rigid substrate of the present invention is fixed, it can be inferred that the reduced time that the electrons diffuse to the external circuit is contributed from the catalyst layer. The electron diffusion time T_{d} of the Pt counter electrode was 8.05 ms, and that of the counter electrode prepared by forming the conductive composition containing 5 wt % of Triton X-100 of the present invention on a rigid substrate was 6.14 ms. Hence, the catalytic capacity of the counter electrode prepared by forming the conductive composition containing 5 wt % of Triton X-100 of the present invention on a rigid substrate is better than that of the Pt counter electrode, resulting in the electron diffusion time reduced. This result is consistent with those obtained from the CV analysis and the EIS analysis.

II. Analysis of IMPS Spectra of DSCs with Flexible Substrates

Since the thickness of the photoanode of the DSC with the rigid substrate of the present invention is fixed, it can be inferred that the reduced time that the electrons diffuse to the external circuit is contributed from the catalyst layer. The electron diffusion time τ_{d} of the Pt counter electrode was 9.30 ms, and that of the counter electrode prepared by forming the conductive composition containing 3 wt % of Triton X-100 of the present invention on a flexible substrate was 8.08 ms. Hence, the catalytic capacity of the counter electrode prepared by forming the conductive composition containing 3 wt % of Triton X-100 of the present invention on a flexible substrate is better than that of the Pt counter electrode, resulting in the electron diffusion time reduced. This result is consistent with those obtained from the CV analysis and the EIS analysis.

In the present invention, the surfactant such as Triton X-100 is added into the conductive polymer PEDOT:PSS to change the conformation of the main chain of PEDOT from the spiral structure into the linear or long spiral structure. Not only a phase separation can be observed from AFM images, but also a red shift of the peak representing the stretching vibration of Cα-Cβ in the 5-membered thiophene ring of PEDOT can further be observed in Raman spectra. These results are evidences showing the conformational change of PEDOT:PSS.

For the catalytic capacity of the counter electrode of the DSC prepared with the conductive composition of the present invention, although a small defect is observed in the counter electrode prepared in the present invention according to the results of the EIS analysis, the catalytic capacity of the counter electrode prepared by forming the conductive composition containing 5 wt % of Triton X-100 of the present invention on a rigid substrate is similar to that of the conventional Pt counter electrode according to the results of the CV analysis. In addition, when a flexible substrate is used to prepare a DSC, the counter electrode prepared by forming the conductive composition containing 3 wt % of Triton X-100 of the present invention on a flexible substrate can be used to replace the conventional Pt electrode, and the performance of the counter electrode of the present invention is better than that of the conventional Pt electrode.

In conclusion, in the present invention, the cheap and easily available conductive polymer is used to prepare the counter electrode through a simple process, and the performance of the obtained counter electrode is similar to and even better than that of the conventional Pt electrode. Hence, the counter electrode prepared with the conductive composition of the present invention can be applied to the DSC.

What is claimed is:

1. A conductive composition, comprising:
poly-(3,4-ethylenedioxythiophene): poly-(styrenesulfonic acid); and
a surfactant having a concentration of 1-10% by weight based on a total weight of the conductive composition,
wherein the conductive composition does not comprise any metal component.

2. The conductive composition as claimed in claim 1, wherein a conductivity of the poly-(3,4-ethylenedioxythiophene): poly-(styrenesulfonic acid) is larger than 500 S/cm.

3. The conductive composition as claimed in claim 1, wherein the surfactant is a nonionic surfactant.

4. The conductive composition as claimed in claim 1, which is used to fabricate a cathode catalyst layer of a battery.

5. The conductive composition as claimed in claim 4, wherein the battery is a dye-sensitized solar cell.

6. The conductive composition as claimed in claim 5, wherein the dye-sensitized solar cell comprises a rigid substrate, which is selected from an ITO glass substrate or a FTO glass substrate.

7. The conductive composition as claimed in claim 5, wherein the dye-sensitized solar cell comprises a flexible substrate, which is selected from a transparent plastic substrate coated with a transparent conductive film or a metal substrate.

8. The conductive composition as claimed in claim 7, wherein the transparent plastic substrate coated with the transparent conductive film is an ITO-PEN substrate.

9. The conductive composition as claimed in claim 7, wherein the metal substrate is a Ti substrate, a Ni substrate or a stainless steel substrate.

10. A cathode catalyst layer, which is fabricated by a conductive composition comprising: poly-(3,4-ethylenedioxythiophene): poly-(styrenesulfonic acid); and a surfactant having a concentration of 1-10% by weight based on a total weight of the conductive composition, wherein the conductive composition does not comprise any metal component.

11. A method for fabricating a cathode catalyst layer, comprising the following steps:
providing a substrate;
mixing poly-(3,4-ethylenedioxythiophene): poly-(styrenesulfonic acid) with a surfactant to obtain a conductive composition, wherein the surfactant has a concentration of 1-10% by weight based on a total weight of the conductive composition, and the conductive composition does not comprise any metal component;
treating the conductive composition with an ultra-sonication process;
coating the substrate with the conductive composition after the ultra-sonication process; and
baking the substrate coated with the conductive composition to obtain a cathode catalytic layer.

12. The method as claimed in claim 11, wherein a conductivity of the poly-(3,4-ethylenedioxythiophene): poly-(styrenesulfonic acid) is larger than 500 S/cm.

13. The method as claimed in claim 11, wherein the surfactant is selected from Triton X-100, SDS or P123.

14. The method as claimed in claim 11, wherein the substrate is a rigid substrate selected from an ITO glass substrate or a FTO glass substrate.

15. The method as claimed in claim 11, wherein the substrate is a flexible substrate selected from a transparent plastic substrate coated with a transparent conductive film or a metal substrate.

16. The method as claimed in claim 15, wherein the transparent plastic substrate coated with the transparent conductive film is an ITO-PEN substrate.

17. The method as claimed in claim 15, wherein the metal substrate is a Ti substrate, a Ni substrate or a stainless steel substrate.

18. The method as claimed in claim 11, which is used to fabricate a dye-sensitized solar cell.
